(19) United States
(12) Patent Application Publication
(10) Pub. No.: US 2017/0372313 A1
(43) Pub. Date: Dec. 28, 2017

(54) ELECTRONIC DEVICE AND SYSTEM FOR PAYMENT

(71) Applicant: SAMSUNG ELECTRONICS CO., LTD., Suwon-si (KR)

(72) Inventors: Minwoo KIM, Seoul (KR); Bokyung KOH, Gwacheon-si (KR); Seunghyuk OH, Seoul (KR); Jaesung KIM, Suwon-si (KR); Joongkeun YU, Seoul (KR); Sunkee LEE, Seongnam-si (KR); Dongho JANG, Hwaseong-si (KR)

(21) Appl. No.: 15/631,315

(22) Filed: Jun. 23, 2017

(30) Foreign Application Priority Data
Jun. 23, 2016 (KR) 10-2016-0078773

(51) Int. Cl. G06Q 20/40; G06Q 20/32

(52) U.S. Cl. CPC G06Q 20/405; G06Q 20/327

(57) ABSTRACT

An electronic device includes a communication module comprising communication circuitry, a memory for storing information about at least one payment means, and a processor. The processor is configured to: receive, using the communication module, identification information about a first external electronic device and order information in connection with a payment from the first external electronic device. Also, the processor is configured to transmit, using the communication module, information about a portion of an amount corresponding to the payment, the identification information, and the order information to a second external electronic device for paying the portion such that the second external electronic device transmits first authentication information for the portion to a third external electronic device capable of performing authentication for the payment. Additionally, processor is configured to transmit, using the communication module, the identification information, the order information, and second authentication information of the electronic device for paying another portion of the amount to the third external electronic device such that the third external electronic device performs authentication for the payment using the identification information, the order information, the first authentication information, and the second authentication information.

### CROSS-REFERENCE TO RELATED APPLICATION

This application is based on and claims priority under 35 U.S.C. §119 to Korean application no. 10-2016-0078773 filed in the Korean intellectual property office on Jun. 23, 2016, the disclosure of which is incorporated by reference herein in its entirety.

### TECHNICAL FIELD

The present disclosure relates generally to an electronic device and system for performing payment.

### BACKGROUND

Mobile payment services using electronic devices are emerging in these days. Existing physical payment means (e.g., a credit card, a check card, etc.) may be replaced by a mobile payment means based on an electronic device. On the other hand, in order to carry out Dutch pay (this term is usually used to mean ‘going Dutch’), each individual pays a certain amount to a merchant, or one person may pay the total amount to the merchant and then the others may transfer their portion to the person's account.

If N persons perform Dutch pay through their electronic devices in an offline store, a total of N payments should be made separately. Also, for this Dutch pay, it may be inconvenient to divide the total amount by N to calculate how much each person should pay.

Meanwhile, in case of trying to perform a payment through online in an offline store, a merchant is required to operate an online server (e.g., Amazon, Auction, etc.) to make an online payment. However, since it costs a lot of money to operate the server directly, it may be difficult to actually operate an online server in an offline store.

### SUMMARY

According to various embodiments of the present disclosure, an electronic device may comprise a communication module comprising communication circuitry; a memory configured to store information about at least one payment means; and a processor configured to receive, using the communication module, identification information about a first external electronic device and order information in connection with a payment from the first external electronic device, to transmit, using the communication module, information about a portion of an amount corresponding to the payment, the identification information, and the order information to a second external electronic device for paying the portion such that the second external electronic device transmits first authentication information for the portion to a third external electronic device capable of performing authentication for the payment, and to transmit, using the communication module, the identification information, the order information, and second authentication information of the electronic device for paying another portion of the amount to the third external electronic device such that the third external electronic device performs authentication for the payment using the identification information, the order information, the first authentication information, and the second authentication information.

According to various embodiments of the present disclosure, a system may comprises a first external electronic device configured to transmit identification information about the first external electronic device and order information in connection with a payment to an electronic device; the electronic device configured to receive an amount corresponding to the payment, the identification information, and the order information from the first external electronic device, to divide the amount corresponding to the payment into a first portion and a second portion, to transmit information about the first portion, the identification information, and the order information to a second external electronic device for paying the first portion, and to transmit first authentication information for the second portion to a third external electronic device capable of performing authentication for the payment; the second external electronic device configured to receive the information about the first portion, the identification information, and the order information from the electronic device, and to transmit second authentication information for the first portion to the third external electronic device; and the third external electronic device configured to perform authentication for the payment by using the first authentication information received from the electronic device and the second authentication information received from the second external electronic device.

According to various embodiments of the present disclosure, an electronic device may comprise a communication module comprising communication circuitry; a memory; and a processor configured to receive, using the communication module, identification information about a third electronic device, order information, and information about a payment means from a first electronic device and a second electronic device in connection with a payment, to request the third electronic device to confirm the order information, and to transmit a transaction ID (TRX ID) and a payment ID (PID) to the first and second electronic devices when the order information is confirmed.

According to various embodiments of the present disclosure, it is possible to provide payment architecture capable of changing an offline payment to an online payment. For example, providing a user interface (UI) for Dutch pay may help respective users to conveniently participate in the Dutch pay offline.

### BRIEF DESCRIPTION OF THE DRAWINGS

The above and/or other aspects, features and attendant advantages of the present disclosure will become more apparent and readily appreciated from the following detailed description, taken in conjunction with the accompanying drawings, in which like reference numerals refer to like elements, and wherein:

FIG. 1 is a block diagram illustrating an example electronic device in a network environment according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIG. 4 is a block diagram illustrating an example architecture of a payment system according to various example embodiments of the present disclosure;

FIG. 5 is a diagram illustrating an example scenario of Dutch pay according to various example embodiments of the present disclosure;

FIG. 6 is a block diagram illustrating an example method for performing an online payment using a mobile token in an offline store according to various example embodiments of the present disclosure;

FIG. 7 is a diagram illustrating an example method for registering a merchant in a payment service server to perform Dutch pay according to various example embodiments of the present disclosure;

FIG. 8 is a diagram illustrating an example interaction of performing Dutch pay between an electronic device and a merchant according to various example embodiments of the present disclosure;

FIG. 9 is a diagram illustrating an example interaction of performing Dutch pay among an electronic device, a payment service server and a payment gateway according to various example embodiments of the present disclosure;

FIG. 10 is a diagram illustrating an example payment method using a one-time code in a case where a payment service server performs the role of a payment gateway according to various example embodiments of the present disclosure;

FIG. 11 is a diagram illustrating an example payment method using a one-time code in a case where a payment gateway is separated from a payment service server according to various example embodiments of the present disclosure;

FIG. 12 is a diagram illustrating an example payment method using a token in a case where a payment service server performs the role of a payment gateway according to various example embodiments of the present disclosure;

FIG. 13 is a diagram illustrating an example payment method using a token in a case where a payment gateway is separated from a payment service server according to various example embodiments of the present disclosure;

FIG. 14 is a diagram illustrating an example user interface for providing information about menu and price to users through an electronic device according to various example embodiments of the present disclosure;

FIG. 15 is a diagram illustrating an example user interface for inputting an amount to be paid through an electronic device according to various example embodiments of the present disclosure;

FIG. 16 is a diagram illustrating an example user interface for calculating a Dutch pay amount according to various example embodiments of the present disclosure;

FIG. 17 is a diagram illustrating an example user interface for transferring a calculated Dutch pay amount to other electronic devices according to various example embodiments of the present disclosure;

FIGS. 18A and 18B are diagrams illustrating another example user interface for transferring a calculated Dutch pay amount to other electronic devices according to various example embodiments of the present disclosure;

FIG. 19 is a diagram illustrating example schemes of receiving payment information for Dutch pay from a store according to various example embodiments of the present disclosure; and

FIG. 20 is a diagram illustrating an example user interface for performing payment with created payment information for Dutch pay according to various example embodiments of the present disclosure.

### DETAILED DESCRIPTION

Hereinafter, various example embodiments of the present disclosure are described in greater detail with reference to the accompanying drawings. While the present disclosure may be embodied in many different forms, specific embodiments of the present disclosure are shown in drawings and are described herein in detail, with the understanding that the present disclosure is not to be considered to be limited thereto. The same reference numerals are used throughout the drawings to refer to the same or like parts.

An expression “comprising” or “may comprise” used in the present disclosure indicates presence of a corresponding function, operation, or element and does not limit an additional at least one function, operation, or element. The term “comprise” or “have” used herein indicates presence of a characteristic, numeral, step, operation, element, component, or combination thereof described in the Specification and does not exclude presence or addition of at least one other characteristic, numeral, step, operation, element, component, or combination thereof.

In the present disclosure, the term “or” includes any combination or the entire combination of together listed words. For example, “A or B” may include A, B, or A and B.

Expressions such as “a first” and “a second” in the present disclosure may represent various elements of the present disclosure, but do not limit corresponding elements, e.g., do not limit order and/or importance of corresponding elements, but may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that a first element is “coupled” to another element, such as a second element, the first element may be “directly coupled” to the second element or “electrically coupled” to the second element through a third element. However, when it is described that a first element is “directly coupled” to a second element, no third element may exist between the first and second elements.

Terms used in the present disclosure are not intended to limit the present disclosure but to illustrate embodiments of the present disclosure. When using in a description of the present disclosure and the appended claims, a singular form includes a plurality of forms unless it is explicitly differently represented.

Unless differently defined, terms including a technical term and a scientific term used herein have the same meaning as may be generally understood by a person of common skill in the art. It should be understood that generally using terms defined in a dictionary have a meaning corresponding to that of a context of related technology and are not understood to have an ideal or excessively formal meaning unless explicitly defined.

In this disclosure, an electronic device may have a communication function. For example, an electronic device may be a smart phone, a tablet PC, a mobile phone, a video phone, an e-book reader, a desktop PC, a laptop PC, a netbook computer, a PDA (personal digital assistant), a PMP (portable multimedia player), an MP3 player, a portable medical device, a digital camera, or a wearable device, such as an HMD (head-mounted device) in the form of electronic glasses, electronic clothes, an electronic bracelet, an electronic necklace, an electronic appcessory, or a smart watch, or the like, but is not limited thereto.

According to some embodiments, an electronic device may be a smart home appliance that involves a communication function, such as a TV (television), a DVD (digital video disk) player, audio equipment, a refrigerator, an air conditioner, a vacuum cleaner, an oven, a microwave, a washing machine, an air cleaner, a set-top box, a TV box, such as Samsung HomeSync™, Apple TV™, and Google TV™, a game console, an electronic dictionary, an electronic key, a camcorder, or an electronic picture frame, or the like, but is not limited thereto.

According to some embodiments, an electronic device may be a medical device, such as MRA (magnetic resonance angiography), MRI (magnetic resonance imaging), CT (computed tomography), and ultrasonography, a navigation device, a GPS (global positioning system) receiver, an EDR (event data recorder), an FDR (flight data recorder), a car infotainment device, electronic equipment for ship, such as a marine navigation system or a gyrocompass), avionics, security equipment, or an industrial or home robot, or the like, but is not limited thereto.

According to some embodiments, an electronic device may be furniture or part of a building or construction having a communication function, an electronic board, an electronic signature receiving device, a projector, or various measuring instruments, such as a water, electric, gas, or a wave meter, or the like, but is not limited thereto. An electronic device disclosed herein may be one of the above-mentioned devices or any combination thereof. As well understood by those skilled in the art, the above-mentioned electronic devices are not to be considered as a limitation of the present disclosure.

According to embodiments, the electronic device may control the activation of a second sensor, based on a signal received through a first sensor, which reduces power consumption of the electronic device compared to a conventional device, in which the second sensor is always activated. The electronic device according to embodiments of the present disclosure may perform a predefined function in response to the signal received through the second sensor.

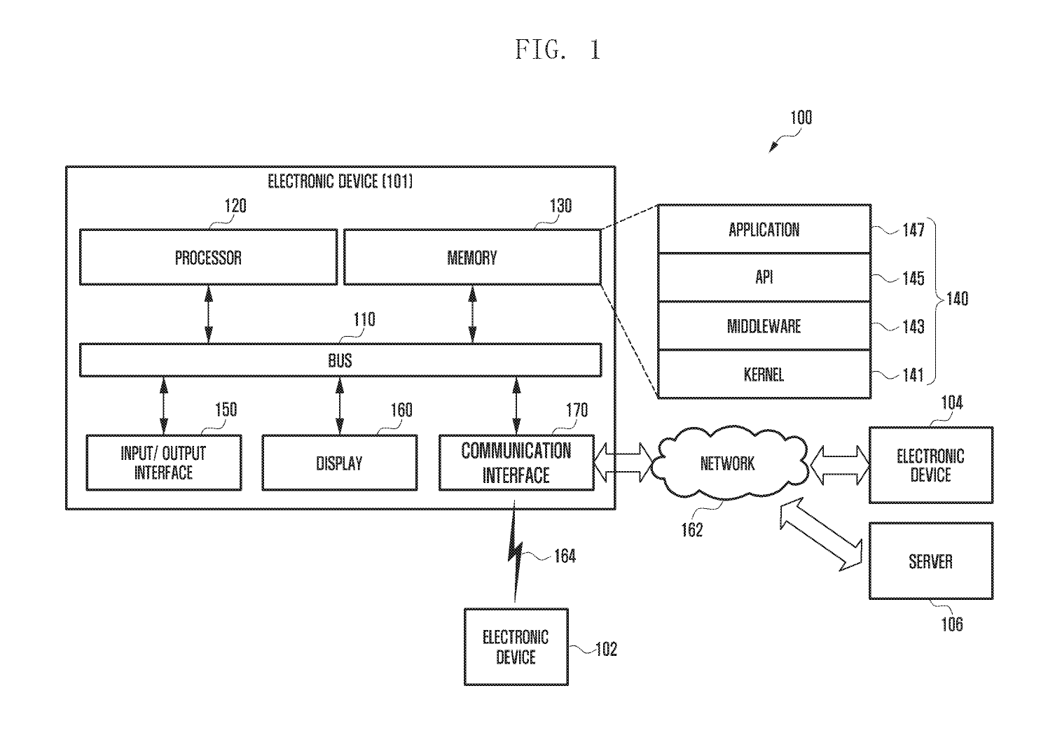

FIG. 1 is a block diagram illustrating an example electronic apparatus in a network environment 100 according to an example embodiment of the present disclosure.

Referring to FIG. 1, the electronic device 101 may include a bus 110, a processor (e.g., including processing circuitry) 120, a memory 130, an input/output interface (e.g., including input/output circuitry) 150, a display 160, and a communication interface (e.g., including communication circuitry) 170.

The bus 110 may be a circuit for interconnecting elements of the electronic device 101 and for allowing a communication, such as by transferring a control message, between the elements.

The processor 120 may include various processing circuitry and can receive commands from the memory 130, the input/output interface 150, the display 160, and the communication interface 170, through the bus 110, can decipher the received commands, and perform operations and/or data processing according to the deciphered commands.

The memory 130 can store commands received from the processor 120 and/or other elements, and/or commands and/or data generated by the processor 120 and/or other elements. The memory 130 may include software and/or programs 140, such as a kernel 141, middleware 143, an application programming interface (API) 145, and an application 147. Each of the programming modules described above may be configured by software, firmware, hardware, and/or combinations of at least two thereof.

The kernel 141 can control and/or manage system resources used for execution of operations and/or functions implemented in other programming modules, such as the middleware 143, the API 145, and/or the applications 147, and can provide an interface through which the middleware 143, the API 145, and/or the applications 147 can access and then control and/or manage an individual element of the electronic apparatus 100.

The middleware 143 can perform a relay function which allows the API 145 and/or the applications 147 to communicate with and exchange data with the kernel 141. In relation to operation requests received from at least one of applications 147, the middleware 143 can perform load balancing in relation to the operation requests by giving a priority in using a system resource, e.g. the bus 110, the processor 120, and/or the memory 130, of the electronic apparatus 100 to at least one application from among the at least one of the applications 147.

The API 145 is an interface through which the applications 147 can control a function provided by the kernel 141 and/or the middleware 143, and may include at least one interface or function for file control, window control, image processing, and/or character control.

The input/output interface 150 may include various input/output circuitry and can receive a command and/or data from a user, and transfer the received command and/or data to the processor 120 and/or the memory 130 through the bus 110. The display 160 can display an image, a video, and/or data to a user.

The communication interface 170 may include various communication circuitry and can establish a communication between the electronic apparatus 100 and another electronic devices 102 and 104 and/or a server 106, and can support short range communication protocols 164, e.g. a wireless fidelity (WiFi) protocol, a BlueTooth (BT) protocol, and a near field communication (NFC) protocol, communication networks, e.g. Internet, local area network (LAN), wide area network (WAN), a telecommunication network, a cellular network, and a satellite network, a plain old telephone service (POTS), or any other similar and/or suitable communication networks, such as network 162. Each of the electronic devices 102 and 104 may be the same type or different types of electronic devices.

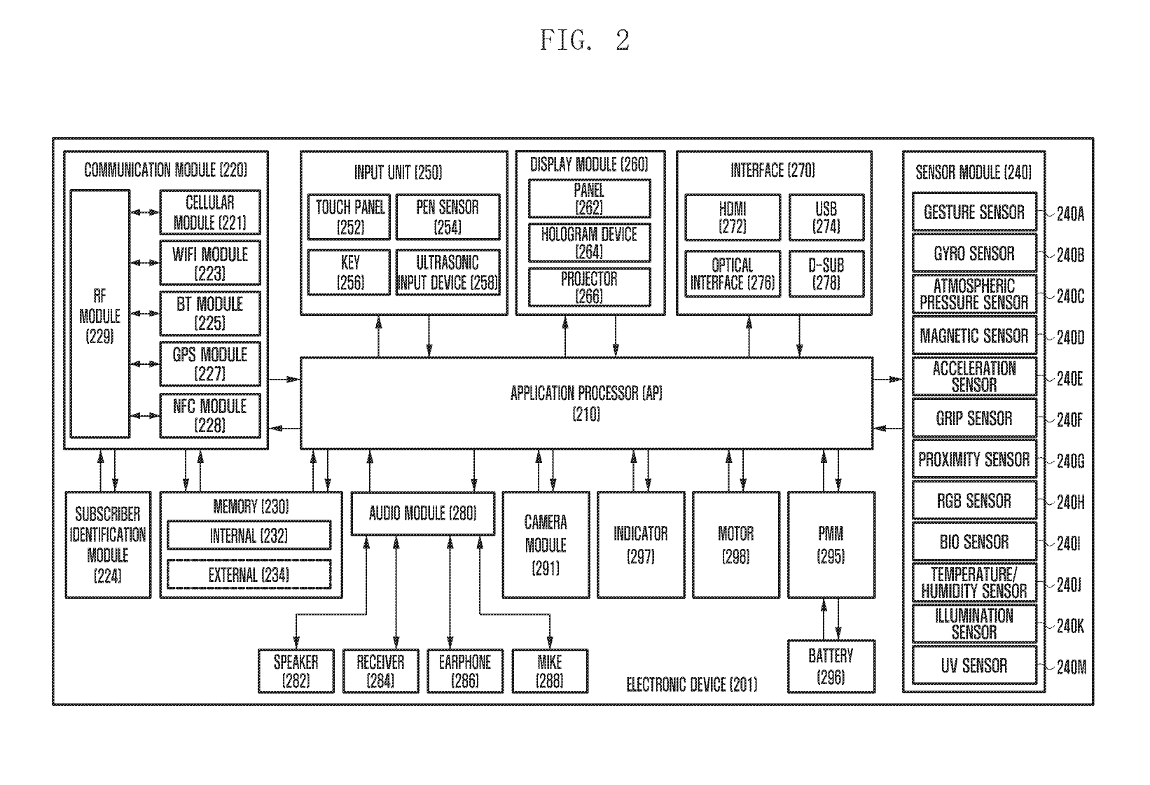

FIG. 2 is a block diagram illustrating an example electronic device 201 in accordance with an example embodiment of the present disclosure. The electronic device 201 may form all or part of the electronic device 101 illustrated in FIG. 1.

Referring to FIG. 2, the electronic device 201 may include at least one application processor (AP) (e.g., including processing circuitry) 210, a communication module (e.g., including communication circuitry) 220, a subscriber identification module (SIM) card 224, a memory 230, a sensor module 240, an input unit (e.g., including input circuitry) 250, a display 260, an interface (e.g., including interface circuitry) 270, an audio module 280, a camera module 291, a power management module 295, a battery 296, an indicator 297, and a motor 298.

The AP 210 may include various processing circuitry and drive an operating system or applications, control a plurality of hardware or software components connected thereto, and also perform processing and operation for various data including multimedia data. The AP 210 may be formed of a system-on-chip (SoC), and may further include a graphic processing unit (GPU).

The communication module 220 may perform a data communication with any other electronic device connected to the electronic device 201 through the network. According to an embodiment, the communication module 220 may include various communication circuitry therein, such as, for example, and without limitation, a cellular module 221, a WiFi module 223, a BT module 225, a GPS module 227, an NFC module 228, and an RF (radio frequency) module 229.

The cellular module 221 may offer a voice call, a video call, a message service, or an Internet service through a communication network, such as long term evolution (LTE), LTE-advanced (LTE-A), code division multiple access (CDMA), wideband CDMA (WCDMA), universal mobile telecommunications system (UNITS), WiBro, or global system for mobile communication (GSM). Additionally, the cellular module 221 may perform identification and authentication of the electronic device in the communication network, using the SIM card 224. According to an embodiment, the cellular module 221 may perform at least part of functions the AP 210 can provide, such as a multimedia control function.

According to an embodiment, the cellular module 221 may include a communication processor (CP), and may be formed of an SoC, for example. Although some elements such as the cellular module 221, such as the CP, the memory 230, or the power management module 295 are shown as separate elements being different from the AP 210 in FIG. 2, the AP 210 may be formed to have at least part of the above elements in an embodiment of the present disclosure.

According to an embodiment, the AP 210 or the cellular module 221 may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 illustrates the cellular module 221, the WiFi module 223, the BT module 225, the GPS module 227 and the NFC module 228 as different blocks, at least two of these modules may be contained in a single IC (integrated circuit) chip or a single IC package, i.e., may be formed as a single SoC.

The RF module 229 may transmit and receive RF signals or any other electric signals, and may include a transceiver, a PAM (power amp module), a frequency filter, or an LNA (low noise amplifier). The RF module 229 may further include any component, e.g., a wire or a conductor, for transmission of electromagnetic waves in a free air space. Although FIG. 2 illustrates that the cellular module 221, the WiFi module 223, the BT module 225, the GPS module 227 and the NFC module 228 share the RF module 229, at least one of these modules may perform transmission and reception of RF signals through a separate RF module in an embodiment of the present disclosure.

The SIM card 224 may be a specific card formed of SIM and may be inserted into a slot formed at a certain location of the electronic device. The SIM card 224 may contain therein an ICCID (integrated circuit card identifier) or an IMSI (international mobile subscriber identity).

The memory 230 may include an internal memory 232 and/or an external memory 234. The internal memory 232 may include at least one of a volatile memory, such as DRAM (dynamic random access memory), SRAM (static RAM), SDRAM (synchronous DRAM), or a nonvolatile memory, such as OTPROM (one time programmable read-only memory), PROM (programmable ROM), EPROM (erasable and programmable ROM), EEPROM (electrically erasable and programmable ROM), mask ROM, flash ROM, NAND flash memory, and NOR flash memory.

According to an embodiment, the internal memory 232 may have the form of an SSD (solid state drive). The external memory 234 may include a flash drive, e.g., CF (compact flash), SD (secure digital), Micro-SD (micro secure digital), Mini-SD (mini secure digital), xD (extreme digital), or memory stick, and may be functionally connected to the electronic device 201 through various interfaces. The electronic device 201 may further include a storage device or medium such as a hard drive.

The sensor module 240 may measure physical quantity or sense an operating status of the electronic device 201, and then convert measured or sensed information into electrical signals. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G a color sensor 240H, such as an RGB (red, green, blue) sensor, a biometric (e.g., bio) sensor 2401, a temperature-humidity sensor 240J, an illumination sensor 240K, and a UV (ultraviolet) sensor 240M. Additionally or alternatively, the sensor module 240 may include an E-nose sensor, an EMG (electromyography) sensor, an EEG (electroencephalogram) sensor, an ECG (electrocardiogram) sensor, an IR (infrared) sensor, an iris scan sensor, or a finger scan sensor. The sensor module 240 may include a control circuit for controlling one or more sensors equipped therein.

The input unit 250 may include various input circuitry, such as, for example, and without limitation, a touch panel 252, a digital pen sensor 254, a key 256, or an ultrasonic input device 258. The touch panel 252 may recognize a touch input in a capacitive, resistive, infrared, or ultrasonic type manner. The touch panel 252 may further include a control circuit. In case of a capacitive type, a physical contact or proximity may be recognized. The touch panel 252 may further include a tactile layer that offers a tactile feedback to a user.

The digital pen sensor 254 may be formed in the same or similar manner as receiving a touch input or by using a separate recognition sheet. The key 256 may include a physical button, an optical key, or a keypad. The ultrasonic input device 258 is capable of identifying data by sensing sound waves with a microphone (MIC) 288 in the electronic device 201 through an input tool that generates ultrasonic signals, thus allowing wireless recognition. According to an embodiment, the electronic device 201 may receive a user input from any external device connected thereto through the communication module 220.

The display 260 may include a panel 262, a hologram device 264, or a projector 266. The panel 262 may be LCD (liquid crystal display), or AM-OLED (active matrix organic light emitting diode)may have a flexible, transparent or wearable form, and may be formed of a single module with the touch panel 252. The hologram device 264 may project a stereoscopic image in the air using interference of light. The projector 266 may project an image onto a screen, which may be located at the inside or outside of the electronic device 201. According to an embodiment, the display 260 may further include a control circuit for controlling the panel 262, the hologram device 264, and the projector 266.

The interface 270 may include various interface circuitry, such as, for example, and without limitation, an HDMI (high-definition multimedia interface) 272, a USB (universal serial bus) 274, an optical interface 276, and a D-sub (d-subminiature) 278, and may be contained in the communication interface 160 shown in FIG. 1. Additionally or alternatively, the interface 270 may include an MHL (mobile high-definition link) interface, an SD (secure digital) card/MMC (multi-media card) interface, or an IrDA (infrared data association) interface.

The audio module 280 may perform a conversion between sounds and electric signals. At least part of the audio module 280 may be contained in the input/output interface 140 shown in FIG. 1. The audio module 280 may process sound information inputted or outputted through a speaker 282, a receiver 284, an earphone 286, or the MIC 288.

The camera module 291 is capable of obtaining still images and moving images, and may include at least one image sensor, such as a front sensor or a rear sensor, a lens, an ISP (image signal processor, or a flash, such as LED or xenon lamp.

The power management module 295 may manage electric power of the electronic device 201 and may include a PMIC (power management integrated circuit), a charger IC, or a battery gauge.

The PMIC may be formed of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include a magnetic resonance type, a magnetic induction type, or an electromagnetic type. Any additional circuit for a wireless charging may be further used, such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 201. The battery 296 may be a rechargeable or solar battery.

The indicator 297 may illustrate thereon a current status, such as a booting, message, or recharging status of part or all of the electronic device 201. The motor 298 may convert an electric signal into a mechanical vibration. The electronic device 201 may include a specific processor, such as GPU, for supporting a mobile TV. This processor may process media data that comply with standards of DMB (digital multimedia broadcasting), DVB (digital video broadcasting), or media flow.

Each of the above-discussed elements of the electronic device disclosed herein may be formed of one or more components, and may have various names according to the type of the electronic device. The electronic device disclosed herein may be formed of at least one of the above-discussed elements without some elements or with additional elements. Some of the elements may be integrated into a single entity that still performs the same functions as those of such elements before integrated.

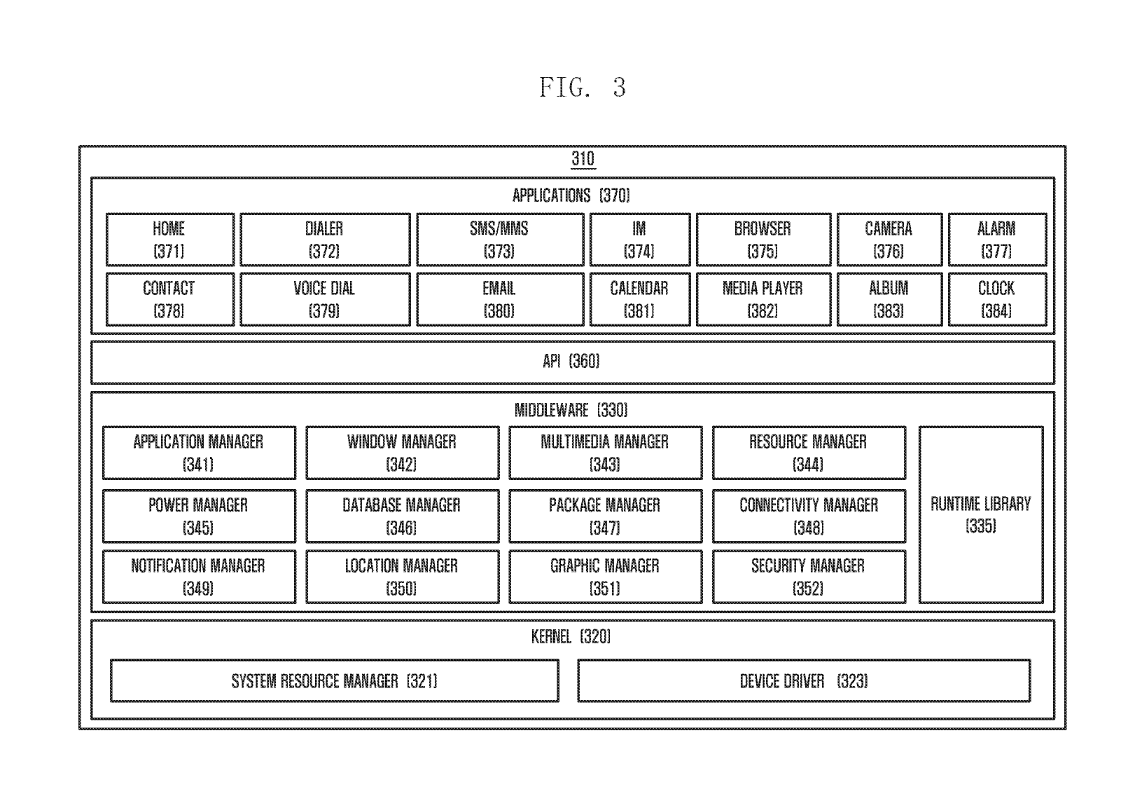

FIG. 3 is a diagram illustrating an example configuration of an example programming module 310 according to an example embodiment of the present disclosure.

The programming module 310 may be stored in the electronic device 100 or may be stored in the electronic device 201 illustrated in FIG. 2. At least a part of the programming module 310 may be implemented in software, firmware, hardware, or a combination of two or more thereof. The programming module 310 may be implemented in hardware 201, and may include an OS controlling resources related to an electronic device and/or various applications 370 executed in the OS. For example, the OS may be Android, iOS, Windows, Symbian, Tizen, or Bada.

Referring to FIG. 3, the programming module 310 may include a kernel 320, middleware 330, an API 360, and/or applications 370.

The kernel 320 may include a system resource manager 321 and/or a device driver 323. The system resource manager 321 may include a process manager, a memory manager, and a file system manager. The system resource manager 321 may perform the control, allocation, or recovery of system resources. The device driver 323 may include a display driver, a camera driver, a Bluetooth driver, a shared memory driver, a USB driver, a keypad driver, a Wi-Fi driver, and/or an audio driver, and may further include an inter-process communication (IPC) driver.

The middleware 330 may include multiple modules previously implemented so as to provide a function used in common by the applications 370, and may provide a function to the applications 370 through the API 360 in order to enable the applications 370 to efficiently use limited system resources within the electronic device. For example, as illustrated in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include a library module used by a complier, in order to add a new function by using a programming language during the execution of the applications 370, and may perform functions which are related to input and output, the management of a memory, or an arithmetic function.

The application manager 341 may manage a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, or a storage space, of at least one of the applications 370.

The power manager 345 may operate together with a basic input/output system (BIOS), may manage a battery or power, and may provide power information used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as Wi-Fi and Bluetooth. The notification manager 349 may display or report, to the user, an event such as an arrival message, an appointment, or a proximity alarm, in such a manner as not to disturb the user. The location manager 350 may manage location information of the electronic device. The graphics manager 351 may manage graphic effects, which are to be provided to the user, and/or a user interface related to the graphic effects. The security manager 352 may provide various security functions used for system security and user authentication. According to an embodiment of the present disclosure, when the electronic device has a telephone function, the middleware 330 may further include a telephony manager for managing a voice and/or video telephony call function of the electronic device.

The middleware 330 may generate and use new middleware module through various functional combinations of the above-described internal element modules, may provide modules specialized according to types of OSs in order to provide differentiated functions, and may dynamically delete some of the existing elements, or may add new elements. Accordingly, the middleware 330 may omit some of the elements described in the embodiments of the present disclosure, may further include other elements, or may replace the some of the elements with elements, each of which performing a similar function and having a different name.

The API 360 is a set of API programming functions, and may be provided with a different configuration according to an OS. In the case of Android or iOS, for example, one API set may be provided to each platform. In the case of Tizen, two or more API sets may be provided to each platform.

The applications 370 may include a preloaded application and/or a third party application, and may include a home 371, dialer 372, a short message service (SMS)/multimedia messaging service (MIMS) 373, instant message (IM) 374, browser 375, camera 376, alarm 377, contact 378, voice dial 379, electronic mail (e-mail) 380, calendar 381, media player 382, album 383, and clock application 384, and any other suitable and/or similar application.

At least a part of the programming module 310 may be implemented by instructions stored in a non-transitory computer-readable storage medium. When the instructions are executed by one or more processors, the one or more processors may perform functions corresponding to the instructions. The non-transitory computer-readable storage medium may be the memory 220. At least a part of the programming module 310 may be executed by the one or more processors 210, and may include a module, a program, a routine, a set of instructions, and/or a process for performing one or more functions.

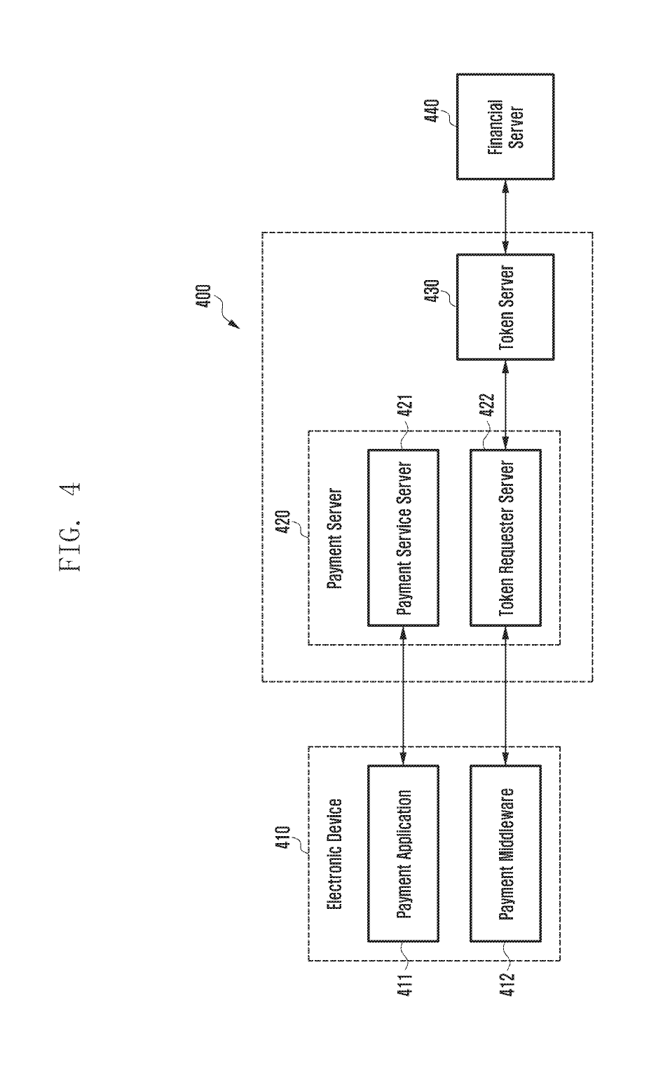

FIG. 4 is a block diagram illustrating an example architecture of a payment system according to various example embodiments of the present disclosure.

According to various embodiments, the payment system 400 may include an electronic device 410 (e.g., the electronic device 101 in FIG. 1 or 201 in FIG. 2) and at least one server such as a payment server 420, a token server 430 (or referred to as a token service provider) and/or a financial server 440 (or referred to as an issuer). The electronic device 410 may include, for example, a payment application 411 (or referred to as a wallet application) and/or a payment middleware 412. The payment server 420 may include a payment service server 421 and/or a token requester server 422 (or referred to as a token requester).

According to various embodiments, the payment application 411 may include, for example, Samsung Pay Application. The payment application 411 may provide a user interface (UI) or user experience (UX), such as wallet UI/UX, associated with payment. For example, the payment application 411 may provide a UI or UX associated with card registration, payment or transaction. Also, the payment application 411 may provide a UI or UX associated with card registration through an optical character reader/recognition (OCR) or an external input (e.g., a user input). Also, the payment application 411 may provide a UI or UX associated with user authentication through identification and verification (ID&V).

According to various embodiments, the electronic device 410 may perform a payment transaction using the payment application 411. For example, the payment application 411 may provide a payment function to a user by executing a simple pay or quick pay or any other equivalent task from which at least some of executable functions are omitted. Using the payment application 411, the user may make a payment and receive payment-related information from the electronic device 410.

According to various embodiments, the payment middleware 412 may include information associated with a card company. For example, the payment middleware 412 may include a software development kit (SDK) of the card company.

According to various embodiments, the payment server 420 may include a management server for an electronic payment or a mobile payment. For example, the payment server 420 may receive payment-related information from the electronic device 410 and then transmit it to the outside or process it.

According to various embodiments, the payment server 420 may transmit and receive information between the electronic device 410 and the token server 430 by using the payment service server 421 and/or the token requester server 422. For example, the payment server 420 may include the payment service server 421, which may manage, for example, card information linked with a user account or a service account (e.g., Samsung account). Also, the payment service server 421 may include an application program interface (API) server (not shown) associated with the payment application 411. Also, the payment service server 421 may provide an account management module (e.g., account integration or Samsung account integration).

According to various embodiments, the token requestor server 422 may provide a suitable interface for processing payment-related information. For example, the token requester server 422 may perform issuance, deletion or activation of payment-related information (e.g., token). Also, the token requester server 422 may be functionally connected to the payment middleware 412 and control information necessary for payment.

According to various embodiments, the payment application 411 contained in the electronic device 410 and the payment service server 421 contained in the payment server 420 may be functionally connected to each other. For example, the payment application 411 may transmit and receive payment-related information to and from the payment service server 421. Similarly, the payment middleware 412 contained in the electronic device 410 and the token requester server 422 contained in the payment server 420 may be functionally connected to each other. For example, the payment middleware 412 may transmit and receive payment-related information to and from the token requester server 422.

According to various embodiments, the token server 430 may issue or manage payment-related information (e.g., token). For example, the token server 430 may control an operation cycle (or referred to as a life cycle) of the token, and the operation cycle may include a creation, modification or deletion function. Also, the token server 430 may include, for example, a token management server, which may manage token provisioning, ID&V, replenishment, or a life cycle, and perform financial server integration.

According to various embodiments, the payment server 420 and the token server 430 may be located in the same or similar areas or in separate areas. For example, the payment server 420 may be contained in the first server, and the token server 430 may be contained in the second server. Alternatively, the payment server 420 and the token server 430 may be separately implemented in one server (e.g., the first or second server).

According to various embodiments, the financial server 440 may perform card issuance. For example, the financial server 440 may include a card issuing server and create information required for payment and to be provided to a user. The user may store this information created by the financial server 440 in the electronic device 410 by using the payment application 411. Also, the financial server 440 may be functionally connected to the token server 430 to transmit and receive necessary information for payment.

Although not shown, the electronic device 410 may transmit track information (track 1/2/3), which is data required for payment, to the payment server 420 as a bit value.

According to various embodiments, track 1 may include the number, name, additional data (e.g., effective date) of the issued card, and any other data entered by the card issuer. Track 2 may include a card number, additional data (e.g., effective date), and a data space to be entered by the card issuer. In a token-based payment method, the value of a token cryptogram (rather than track 1/2/3) may be converted into a bit and released through a magnetic signal.

Here, the token is an identifier (ID) for identifying a card received from the card company when registering the card in the electronic device. Transaction data is transaction-related information including an expiration date of a card used for payment, a merchant ID of PoS, etc., and may be made by combining some of transaction-related information. Using the format of existing track, it is possible to receive token information without any change on the PoS and send it to a card network (e.g., VISA, MASTER, etc.). The token may include at least a number capable of identifying the card company and the like.

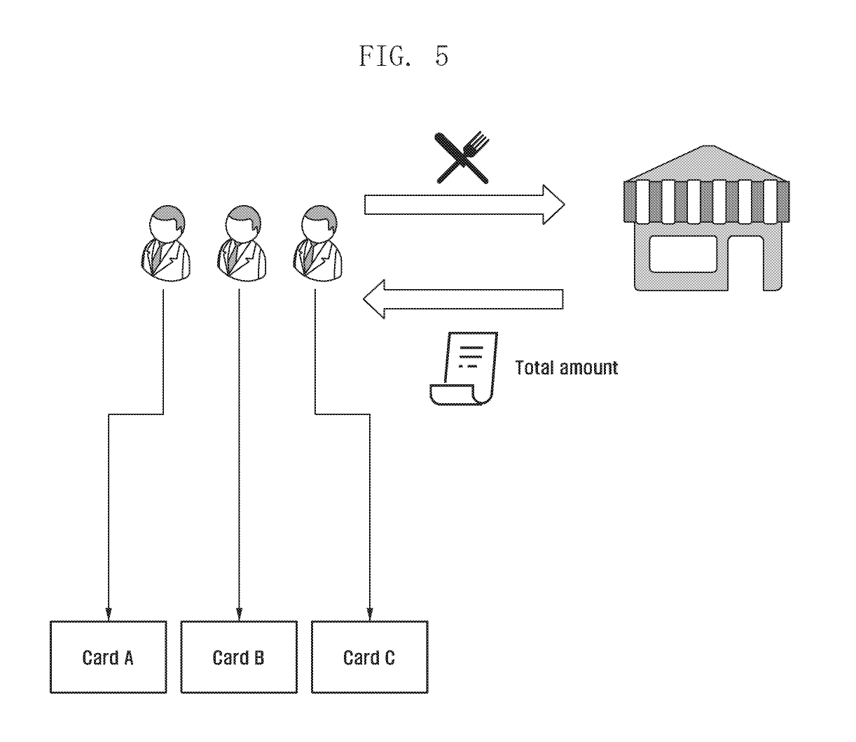

FIG. 5 is a diagram illustrating an example scenario of Dutch pay according to various example embodiments of the present disclosure.

When two or more consumers collectively make a purchase in a store, the store may inform the total amount and each consumer may make Dutch pay for the total amount. Namely, respective persons participating Dutch pay may pay their own amounts (herein, also referred to as portion) with a payment means (e.g., cards A, B, C) stored in their respective electronic devices (e.g., the electronic device 101).

According to a mobile payment method typically performed in an offline store, consumers may inform the store about each amount to be paid, and when the amount is inputted into a PoS terminal, each consumer may tag his or her payment means (e.g., a cash card, a credit card, a gift coupon, etc.) to the PoS terminal to perform a payment. This approach may be inconvenient in that the total amount cannot be paid at once for the consumer or the store, and the payment should be made for the number of persons.

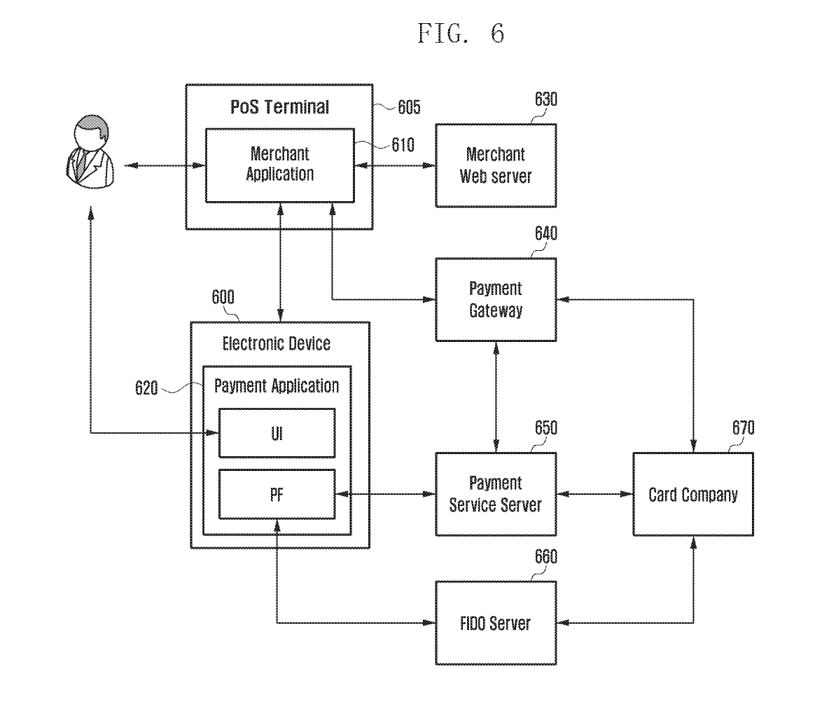

FIG. 6 is a block diagram illustrating an example method for performing an online payment using a mobile token in an offline store according to various example embodiments of the present disclosure.

According to various embodiments, the method for performing an online payment using a mobile token in an offline store may be as follows. This method is a Korean payment model that performs the online payment using the token. For example, the Korean payment model may perform the online payment by using an electronic device 600, a point of sales (PoS) terminal 605, a merchant web server 630, a payment operator or a payment gateway (PG) 640, a payment service server 650, a fast identity online (FIDO) server 660, and a card company 670.

According to various embodiments, a merchant application 610 of the PoS terminal 605 allows a user to select and determine articles to be purchased. The merchant application 610 may create an order identification (OID) as to order information at the merchant web server 630. Alternatively, the merchant application 610 may directly create the OID as to the order information and share the created OID with the merchant web server 630.

According to various embodiments, the merchant application 610 of the PoS terminal 605 may notify the selected payment means (e.g., Samsung Pay) to the merchant web server 630. The merchant web server 630 may transmit at least one kind of information (e.g., order information, OID, a merchant ID (MID)) to the payment gateway 640 through the merchant application 610 and also receive at least one kind of information (e.g., a payment ID (PID), a transaction ID (TRX ID)) from the payment gateway 640 through the merchant application 610.

According to various embodiments, the merchant application 610 of the PoS terminal 605 may deliver at least one kind of information (e.g., PID, TRX ID) to the payment application 620 via a JavaScript software development kit (SDK).

According to various embodiments, the payment application 620 of the electronic device 600 may deliver the TRX ID to the payment gateway 640 corresponding to the PID through the payment service server 650 and also receive corresponding order information.

According to various embodiments, the electronic device 600 may display the order information in a UI (e.g., a web payment UI or a web checkout UI) through the payment application 620, and the user of the electronic device 600 may confirm the order information and then perform a payment. For example, the user may select a payment means (e.g., a cash card, a credit card, a gift coupon, etc.) and authenticate biometric information to proceed with the payment.

According to various embodiments, the payment application 620 may send a FIDO authentication result to the FIDO server 660. Also, the payment application 620 may request a onetime code (OTC) to the card company 670 through the payment service server 650. The card company 670 may confirm the authentication result through the FIDO server 660 and, if the authentication is confirmed, provide the OTC to the payment service server 650. Then, the payment service server 650 may deliver at least one kind of information (e.g., TRX ID, OTC) to the payment gateway 640. The payment gateway 640 may perform a payment with regard to the order information and notify a payment result to the merchant application 610.

According to various embodiments, the Korean payment model may not be a general form for a user to purchase articles in an offline store because the store (or merchant) has to directly operate a server (e.g., the merchant web server 630).

Hereinafter, a method for performing Dutch pay using an online payment in an offline store will be described in detail. For example, in order to perform Dutch pay, the store should present a single receipt form containing a total payment amount to a plurality of users.

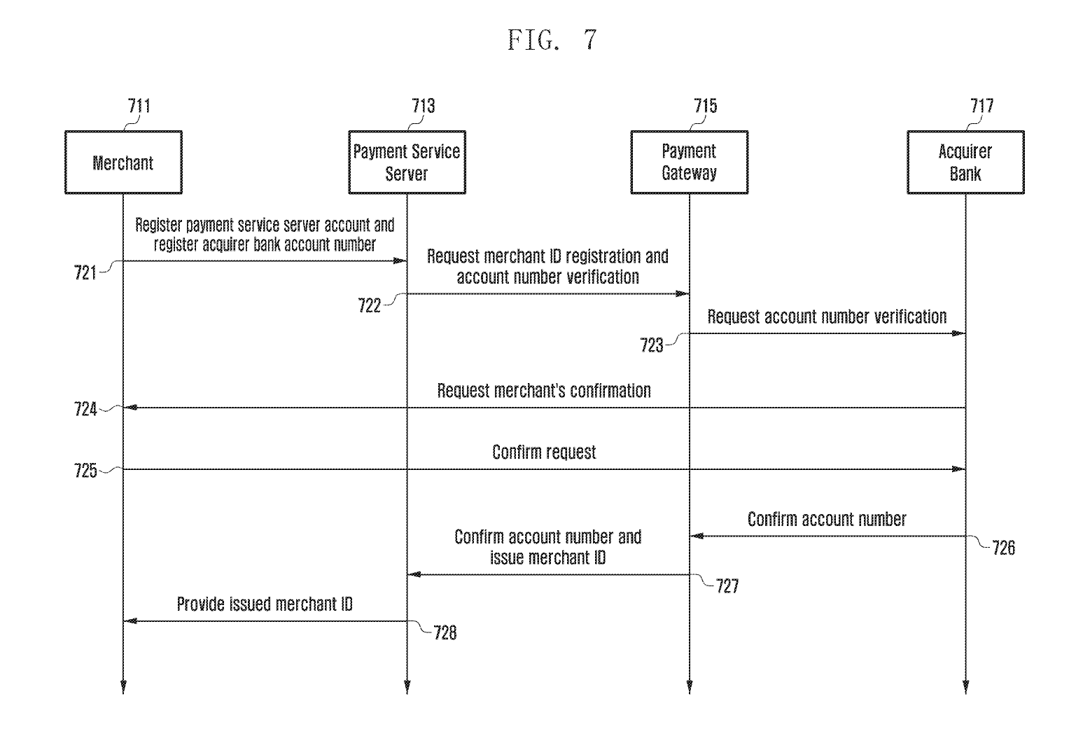

FIG. 7 is a diagram illustrating an example method for registering a merchant in a payment service server to perform Dutch pay according to various example embodiments of the present disclosure.

According to various embodiments, in order to use an online payment method that complies with a Dutch pay scenario, a payment service server 713 and a payment gateway 715 should be able to recognize a merchant 711. Therefore, the normal merchant 711 having no separate server may be connected to the payment service server 713 by using an electronic device such as a computer, a mobile phone, a PoS terminal, or the like, and may be registered in the payment service server 713. For example, the merchant 711 may access the payment service server 713 through a client application or web page in the electronic device. Here, the payment service server 713 may operate a server application web server corresponding to the client application or web page. Through the registration, the merchant 711 may provide information about the merchant 711 to the payment service server 713 and the payment gateway 715, and also obtain a merchant ID (MID). Meanwhile, the MID may mean an identifier by which the payment gateway 715 can recognize the merchant 711. A specific scenario for the registration process is as follows.

According to various embodiments, at operation 721, the merchant 711 may register an account in the payment service server 713 and also register an account number regarding an acquirer bank 717. For example, when registering the account, a representative name, an e-mail, a phone number, a trade name, merchant classification information, and the like may be registered together.

According to various embodiments, at operation 722, the payment service server 713 may request the payment gateway 715 to register the merchant ID (MID) and verify the account number.

According to various embodiments, at operation 723, the payment gateway 715 may request the acquirer bank 717 to verify whether the account number is registered.

According to various embodiments, at operation 724, the acquirer bank 717 may request the merchant 711 to confirm whether the registration of the account number is requested.

According to various embodiments, at operation 725, the merchant 711 may confirm the request of the acquirer bank 717.

According to various embodiments, at operation 726, the acquirer bank 717 may confirm to the payment gateway 715 that the account number of the merchant 711 is correct.

According to various embodiments, at operation 727, the payment gateway 715 may confirm to the payment service server 713 that the account number of the merchant 711 is correct, and may also issue the MID to the payment service server 713.

According to various embodiments, at operation 728, the payment service server 713 may provide the issued MID to the merchant 711.

Meanwhile, the merchant 711 may receive a private key for a secure connection with the payment service server 713, and may perform an https (http over secure socket layer) connection through a web page.

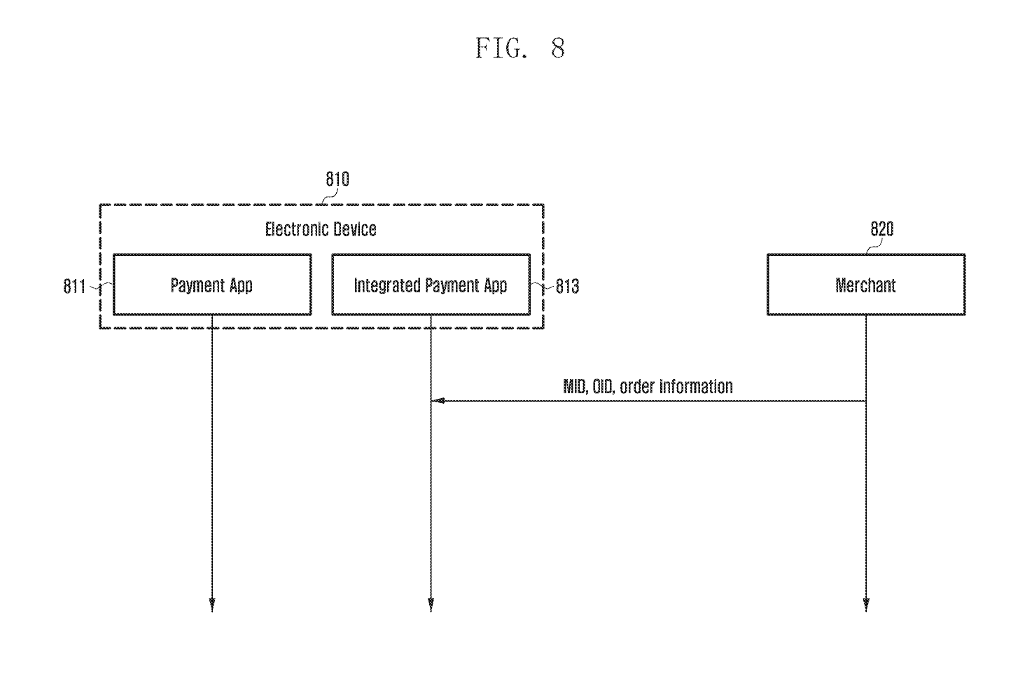

FIG. 8 is a diagram illustrating an example interaction for performing Dutch pay between an electronic device and a merchant according to various example embodiments of the present disclosure.

According to various embodiments, a merchant 820 may provide at least one kind of information (e.g., MID, OID, order information) to an electronic device 810. For example, the merchant 820 may provide information to the electronic device 810 by using a barcode, a QR code, a P2P communication (e.g., NFC), or the like.

According to various embodiments, the electronic device 810 may include a payment application 811 and an integrated payment application 813. For example, the integrated payment application 813 may perform the function of a merchant application (e.g., 610 in FIG. 6) in an in-app payment form, and may also deliver information about payment to a payment service server and a merchant server.

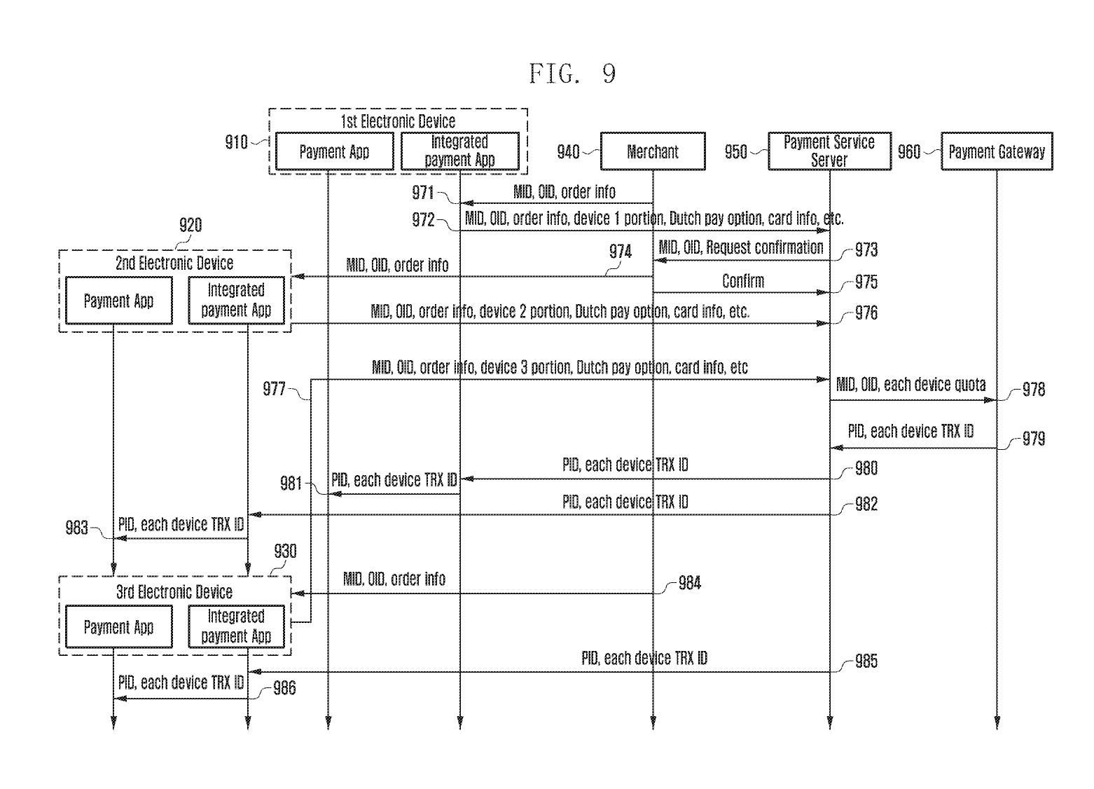

FIG. 9 is a diagram illustrating an example interaction of performing Dutch pay among an electronic device, a payment service server and a payment gateway according to various example embodiments of the present disclosure.

According to various embodiments, each of the first electronic device 910, the second electronic device 920, and the third electronic device 930 may perform a payment of articles purchased at a merchant 940 through Dutch pay.

According to various embodiments, at operations 971, 974 and 984, each of the first, second and third electronic devices 910, 920 and 930 may receive MID, OID, order information (e.g., a payment amount, a purchased article) from the merchant 940. For example, the OID may mean a value that allows the merchant 940 to identify each order.

According to various embodiments, a user of each of the electronic devices 910, 920 and 930 may select a Dutch pay option by using an integrated payment application, and may enter an amount to be paid by each user (e.g., each user's portion) in a payment amount and information about a card for payment. At operations 972, 976 and 977, each of the electronic devices 910, 920 and 930 may transmit, to the payment service server 950, the MID, the OID, and the order information, received from the merchant 940, and information indicating whether to proceed with Dutch pay, the number of persons participating in Dutch pay, the amount to be paid by each user, the information about a card for payment, and the like.

According to various embodiments, at operation 973, the payment service server 950 may transmit the MID, the OID, and the order information, received from the electronic devices 910, 920 and 930, to the merchant 940 corresponding to the MID, and also request confirmation of payment.

According to various embodiments, at operation 975, the merchant 940 may reply to the confirmation request of the payment service server 950. For example, the merchant 940 may confirm to the payment service server 950, based on the OID, that the order information is created in the merchant 940.

According to various embodiments, upon completion of the confirmation at operation 975, the payment service server 950 may confirm, based on the OID, whether the sum of payment request amounts of respective users is equal to the payment amount of the order information.

According to various embodiments, when the sum of payment request amounts of respective users is equal to the payment amount of the order information, the payment service server 950 may transmit, at operation 978, at least one of the MID, the OID, and the payment request amount to the payment gateway 960 corresponding to the card selected by the user.

According to various embodiments, at operation 979, the payment gateway 960 may transmit a PID and a TRX ID of each of the electronic devices 910, 920 and 930 to the payment service server 950. For example, if the payment service server 950 plays the role of the payment gateway 960, the payment service server 950 may internally create the TRX ID.

According to various embodiments, at operations 980, 982 and 985, the payment service server 950 may transmit the PID (a value for identifying the payment gateway 960) and the TRX ID to the first, second and third electronic devices 910, 920 and 930.

According to various embodiments, each of the electronic device 910, 920 and 930 may include a payment application for performing authentication of a token. For example, the payment application may receive the PID and the TRX ID from the integrated payment application at operations 981, 983 and 986, and may perform a payment operation.

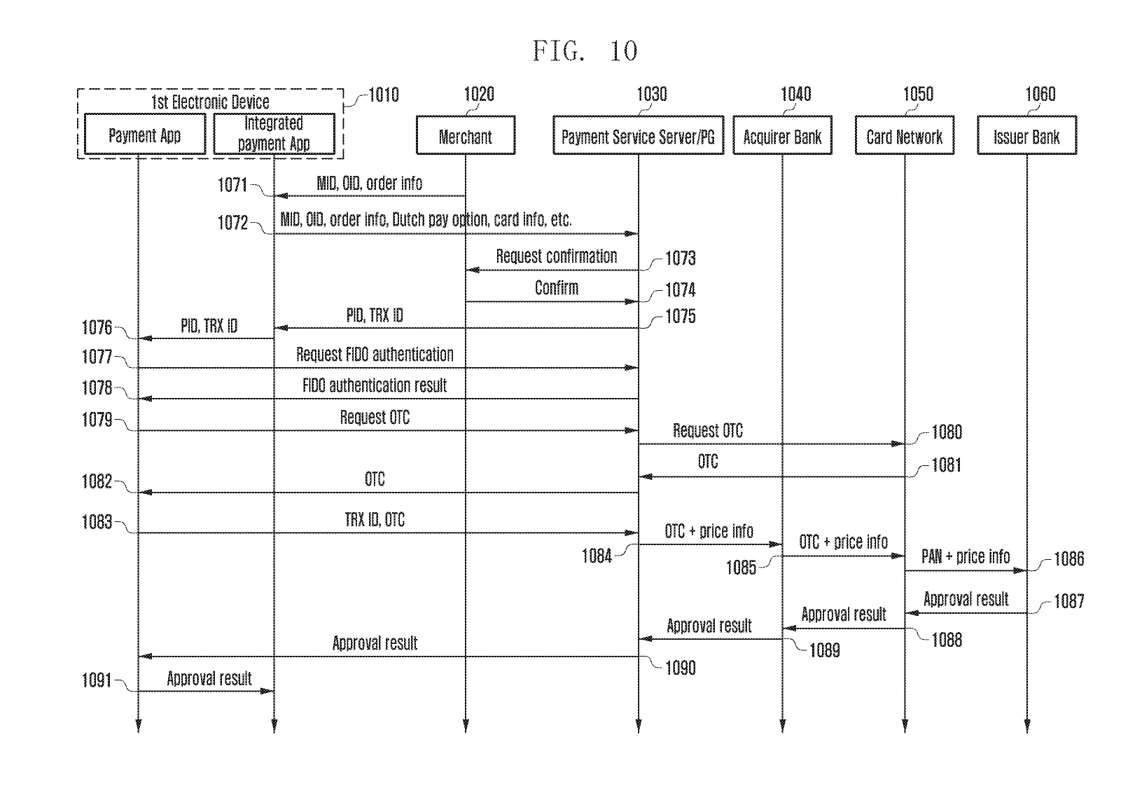

According to various embodiments, subsequent payment operations may be referred to FIGS. 10 to 13. For example, the Korean model may include a personal authentication operation through a FIDO and a payment operation through issuance of an OTC, and the US model may perform operations similar to the offline payment by transmitting a token and a cryptogram. In particular, unlike the existing offline payment, the PID and the TRX ID may be transmitted to each payment gateway so that the payment gateway can know which transaction is a target of the payment operation.

According to various embodiments, the payment application may perform the function of transmitting the token. While only the OTC or the token and the cryptogram are transmitted in the existing offline payment, the TRX ID may be transmitted together because the payment service server or the payment gateway should know which payment is performed. The remainder is similar to the existing offline payment.

According to various embodiments, FIGS. 10 to 13 illustrate separately cases where the payment service server performs, and does not perform, the role of the payment gateway as well as the Korean model and the US model.

FIG. 10 is a diagram illustrating an example payment method using a one-time code in a case where a payment service server performs the role of a payment gateway according to various embodiments of the present disclosure.

According to various embodiments, FIG. 10 illustrates a case where the payment service server performs the role of the payment gateway in the Korean model. For example, in FIG. 10, the payment service server and the payment gateway may be described as the payment service server 1030 without distinguishing between them.

According to various embodiments, at operation 1071, the first electronic device 1010 may receive MID, OID, order information (e.g., a payment amount, a purchased article) from a merchant 1020. For example, the OID may mean a value that allows the merchant 1020 to identify each order.

According to various embodiments, a user of the first electronic device 1010 may select a Dutch pay option by using an integrated payment application, and may enter a user's portion of a payment amount and information about a card for payment. For example, at operation 1072, the first electronic device 1010 may transmit, to the payment service server 1030, at least one of the MID, the OID, the order information, which are received from the merchant 1020, information indicating whether to proceed with Dutch pay, the number of persons participating in Dutch pay, the user's portion of a payment amount, and the information about a card for payment.

According to various embodiments, at operation 1073, the payment service server 1030 may transmit the MID, the OID, and the order information, received from the first electronic device 1010, to the merchant 1020 corresponding to the MID, and may also request confirmation of payment.

According to various embodiments, at operation 1074, the merchant 1020 may reply to the confirmation request of the payment service server 1030. For example, the merchant 1020 may confirm to the payment service server 1030, based on the OID, that the order information is created in the merchant 1020.

According to various embodiments, at operation 1075, the payment service server 1030 may transmit a PID and a TRX ID to the first electronic device 1010. Namely, since the payment service server 1030 plays the role of the payment gateway, the payment service server 1030 may internally create the TRX ID.

According to various embodiments, the first electronic device 1010 may include a payment application for performing authentication of a token. For example, at operation 1076, the first electronic device 1010 may deliver the PID and the TRX ID from the integrated payment application to the payment application, and may perform a payment operation.

According to various embodiments, at operation 1077, the first electronic device 1010 may send a request for FIDO authentication to the payment service server 1030. For example, at operation 1078, the payment service server 1030 may transmit a FIDO authentication result to the first electronic device 1010.

According to various embodiments, if the FIDO authentication is successfully performed, the first electronic device 1010 may send a request for OTC to the payment service server 1030 at operation 1079.

According to various embodiments, at operation 1080, the payment service server 1030 may deliver the OTC request to a card network 1050. For example, at operation 1081, the payment service server 1030 may receive an OTC from the card network 1050.

According to various embodiments, at operation 1082, the payment service server 1030 may transmit the OTC to the first electronic device 1010. Then, at operation 1083, the payment service server 1030 may receive a TRX ID and the OTC from the first electronic device 1010.

According to various embodiments, at operation 1084, the payment service server 1030 may transmit the OTC and price information to an acquirer bank 1040. Then, at operation 1085, the acquirer bank 1040 may deliver the OTC and the price information to the card network 1050. At operation 1086, the card network 1050 may send a primary account number (PAN) and the price information to an issuer bank 1060. For example, the card network 1050 may send the PAN corresponding to the received OTC to the issuer bank 1060.

According to various embodiments, the issuer bank 1060 may transmit an approval result to the card network 1050 at operation 1087, and the card network 1050 may deliver the approval result to the acquirer bank 1040 at operation 1088. Also, the acquirer bank 1040 may send the approval result to the payment service server 1030 at operation 1089. Then, at operation 1090, the payment service server 1030 may send the approval result to the first electronic device 1010. For example, the approval result may be sent to the payment application of the first electronic device 1010 and then delivered to the integrated payment application at operation 1091.

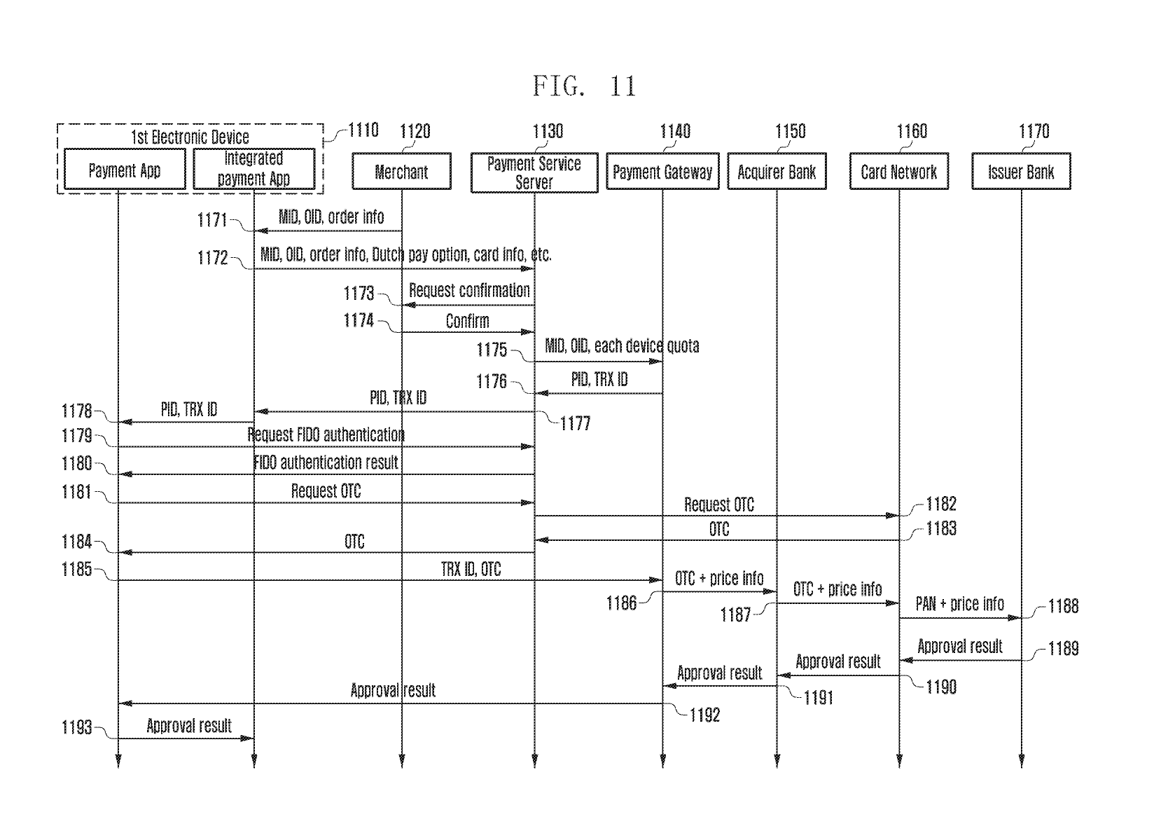

FIG. 11 is a diagram illustrating an example payment method using a one-time code in a case where a payment gateway is separated from a payment service server according to various example embodiments of the present disclosure.

According to various embodiments, FIG. 11 illustrates a case where the payment gateway is separated from the payment service server in the Korean model. For example, in FIG. 11, unlike FIG. 10, the payment service server 1130 and the payment gateway 1140 may be described by distinguishing between them.

According to various embodiments, at operation 1171, the first electronic device 1110 may receive MID, OID, order information (e.g., a payment amount, a purchased article) from a merchant 1120. For example, the OID may mean a value that allows the merchant 1120 to identify each order.

According to various embodiments, a user of the first electronic device 1110 may select a Dutch pay option by using an integrated payment application, and may enter a user's portion of a payment amount and information about a card for payment. For example, at operation 1172, the first electronic device 1110 may transmit, to the payment service server 1130, at least one of the MID, the OID, the order information, which are received from the merchant 1120, information indicating whether to proceed with Dutch pay, the number of persons participating in Dutch pay, the user's portion of a payment amount, and the information about a card for payment.

According to various embodiments, at operation 1173, the payment service server 1130 may transmit the MID, the OID, and the order information, received from the first electronic device 1110, to the merchant 1120 corresponding to the MID, and may also request confirmation of payment.

According to various embodiments, at operation 1174, the merchant 1120 may reply to the confirmation request of the payment service server 1130. For example, the merchant 1120 may confirm to the payment service server 1130, based on the OID, that the order information is created in the merchant 1120.

According to various embodiments, at operation 1175, the payment service server 1130 may transmit information such as the MID, the OID, a payment amount, etc. to the payment gateway 1140. Then, at operation 1176, the payment gateway 1140 may send a PID and a TRX ID to the payment service server 1130. In this case, since the payment service server 1130 and the payment gateway 1140 are separated from each other, the payment gateway 1140 may create the TRX ID.

According to various embodiments, at operation 1177, the payment service server 1130 may transmit the PID and the TRX ID to the first electronic device 1110.

According to various embodiments, the first electronic device 1110 may include a payment application for performing authentication of a token. For example, at operation 1178, the first electronic device 1110 may deliver the PID and the TRX ID from the integrated payment application to the payment application, and may perform a payment operation.

According to various embodiments, at operation 1179, the first electronic device 1110 may send a request for FIDO authentication to the payment service server 1130. For example, at operation 1180, the payment service server 1130 may transmit a FIDO authentication result to the first electronic device 1110.

According to various embodiments, if the FIDO authentication is successfully performed, the first electronic device 1110 may send a request for OTC to the payment service server 1130 at operation 1181.

According to various embodiments, at operation 1182, the payment service server 1130 may deliver the OTC request to a card network 1160. For example, at operation 1183, the payment service server 1130 may receive an OTC from the card network 1160.

According to various embodiments, at operation 1184, the payment service server 1130 may transmit the OTC to the first electronic device 1110. Then, at operation 1185, the payment gateway 1140 may receive a TRX ID and the OTC from the first electronic device 1110.

According to various embodiments, at operation 1186, the payment gateway 1140 may transmit the OTC and price information to an acquirer bank 1150. Then, at operation 1187, the acquirer bank 1150 may deliver the OTC and the price information to the card network 1160. At operation 1188, the card network 1160 may send a PAN and the price information to an issuer bank 1170. For example, the card network 1160 may send the PAN corresponding to the received OTC to the issuer bank 1170.

According to various embodiments, the issuer bank 1170 may transmit an approval result to the card network 1160 at operation 1189, and the card network 1160 may deliver the approval result to the acquirer bank 1150 at operation 1190. Also, the acquirer bank 1150 may send the approval result to the payment gateway 1140 at operation 1191. Then, at operation 1192, the payment gateway 1140 may send the approval result to the first electronic device 1110. For example, the approval result may be sent to the payment application of the first electronic device 1110 and then delivered to the integrated payment application at operation 1193.

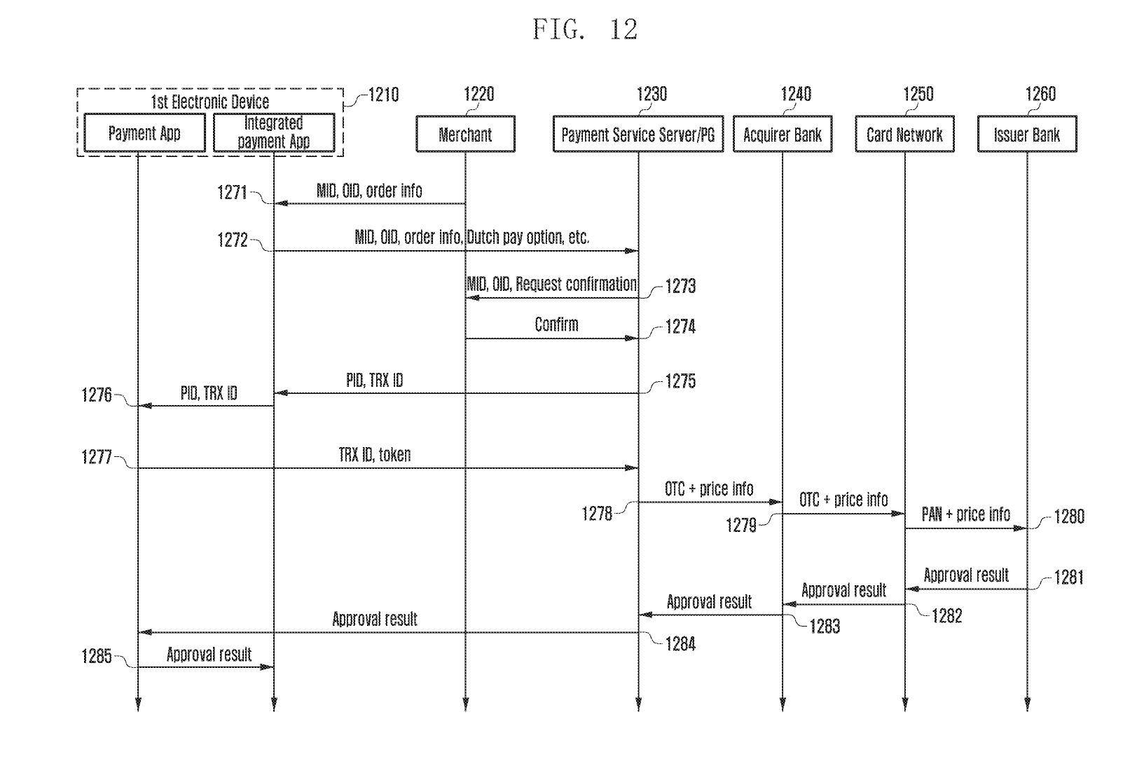

FIG. 12 is a diagram illustrating an example payment method using a token in a case where a payment service server performs the role of a payment gateway according to various embodiments of the present disclosure.

According to various embodiments, FIG. 12 illustrates a case where the payment service server performs the role of the payment gateway in the US model. For example, in FIG. 12, the payment service server and the payment gateway may be described as the payment service server 1230 without distinguishing between them.

According to various embodiments, at operation 1271, the first electronic device 1210 may receive MID, OID, order information (e.g., a payment amount, a purchased article) from a merchant 1220. For example, the OID may mean a value that allows the merchant 1220 to identify each order.

According to various embodiments, a user of the first electronic device 1210 may select a Dutch pay option by using an integrated payment application, and may enter a user's portion of a payment amount and information about a card for payment. For example, at operation 1272, the first electronic device 1210 may transmit, to the payment service server 1230, at least one of the MID, the OID, the order information, which are received from the merchant 1220, information indicating whether to proceed with Dutch pay, the number of persons participating in Dutch pay, the user's portion of a payment amount, and the information about a card for payment.

According to various embodiments, at operation 1273, the payment service server 1230 may transmit the MID, the OID, and the order information, received from the first electronic device 1210, to the merchant 1220 corresponding to the MID, and may also request confirmation of payment.

According to various embodiments, at operation 1274, the merchant 1220 may reply to the confirmation request of the payment service server 1230. For example, the merchant 1220 may confirm to the payment service server 1230, based on the OID, that the order information is created in the merchant 1220.

According to various embodiments, at operation 1275, the payment service server 1230 may transmit a PID and a TRX ID to the first electronic device 1210. Namely, since the payment service server 1230 plays the role of the payment gateway, the payment service server 1230 may internally create the TRX ID.

According to various embodiments, the first electronic device 1210 may include a payment application for performing authentication of a token. For example, at operation 1276, the first electronic device 1210 may deliver the PID and the TRX ID from the integrated payment application to the payment application, and may perform a payment operation.

According to various embodiments, at operation 1277, the first electronic device 1210 may send a TRX ID and a token to the payment service server 1230. Namely, unlike the Korean model, the US model may omit a separate FIDO authentication procedure and may use an actual token instead of the OTC.

According to various embodiments, at operation 1278, the payment service server 1230 may transmit the token and price information to an acquirer bank 1240. Then, at operation 1279, the acquirer bank 1240 may deliver the token and the price information to a card network 1250. At operation 1280, the card network 1250 may send a PAN and the price information to an issuer bank 1260. For example, the card network 1250 may send the PAN corresponding to the received token to the issuer bank 1260.

According to various embodiments, the issuer bank 1260 may transmit an approval result to the card network 1250 at operation 1281, and the card network 1250 may deliver the approval result to the acquirer bank 1240 at operation 1282. Also, the acquirer bank 1240 may send the approval result to the payment service server 1230 at operation 1283. Then, at operation 1284, the payment service server 1230 may send the approval result to the first electronic device 1210. For example, the approval result may be sent to the payment application of the first electronic device 1210 and then delivered to the integrated payment application at operation 1285.

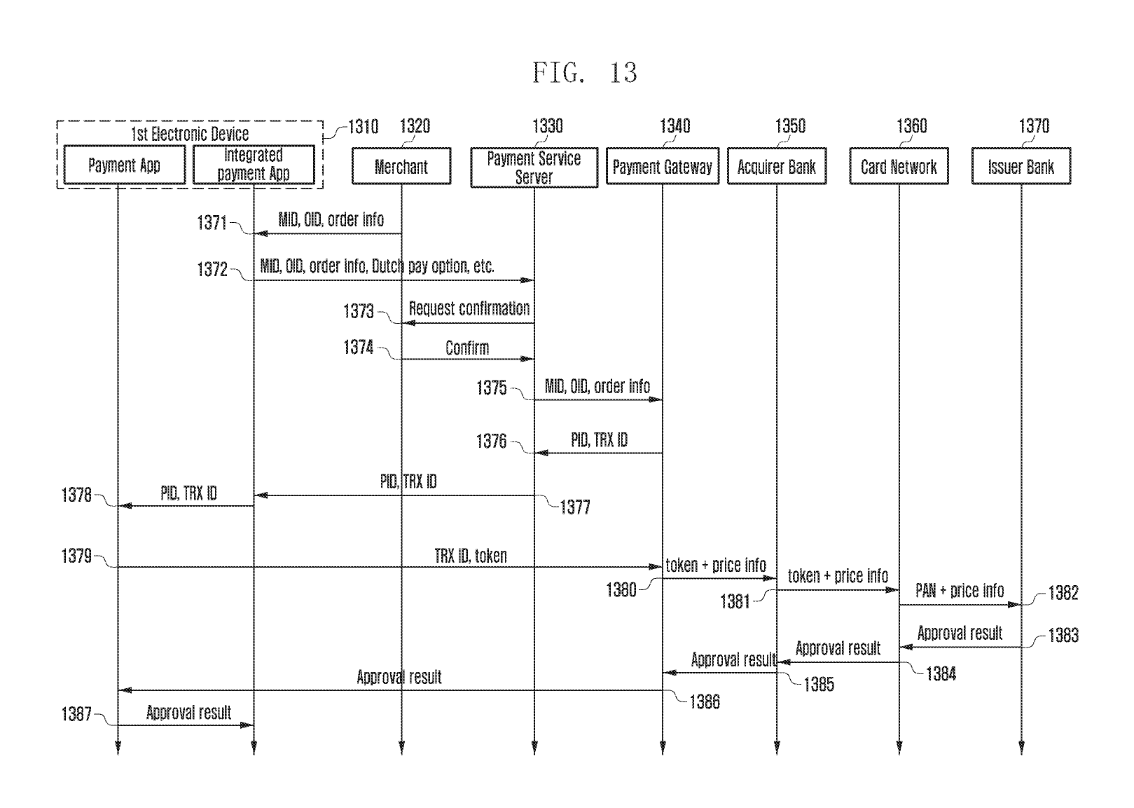

FIG. 13 is a diagram illustrating an example payment method using a token in a case where a payment gateway is separated from a payment service server according to various example embodiments of the present disclosure.

According to various embodiments, FIG. 13 illustrates a case where the payment gateway is separated from the payment service server in the US model. For example, in FIG. 13, unlike FIG. 12, the payment service server 1330 and the payment gateway 1340 may be described by distinguishing between them.

According to various embodiments, at operation 1371, the first electronic device 1310 may receive MID, OID, order information (e.g., a payment amount, a purchased article) from a merchant 1320. For example, the OID may mean a value that allows the merchant 1320 to identify each order.

According to various embodiments, a user of the first electronic device 1310 may select a Dutch pay option by using an integrated payment application, and may enter a user's portion of a payment amount and information about a card for payment. For example, at operation 1372, the first electronic device 1310 may transmit, to the payment service server 1330, at least one of the MID, the OID, the order information, which are received from the merchant 1320, information indicating whether to proceed with Dutch pay, the number of persons participating in Dutch pay, the user's portion of a payment amount, and the information about a card for payment.

According to various embodiments, at operation 1373, the payment service server 1330 may transmit the MID, the OID, and the order information, received from the first electronic device 1310, to the merchant 1320 corresponding to the MID, and may also request confirmation of payment.

According to various embodiments, at operation 1374, the merchant 1320 may reply to the confirmation request of the payment service server 1330. For example, the merchant 1320 may confirm to the payment service server 1330, based on the OID, that the order information is created in the merchant 1320.

According to various embodiments, at operation 1375, the payment service server 1330 may transmit information such as the MID, the OID, a payment amount, etc. to the payment gateway 1340. Then, at operation 1376, the payment gateway 1340 may send a PID and a TRX ID to the payment service server 1330. In this case, since the payment service server 1330 and the payment gateway 1340 are separated from each other, the payment gateway 1340 may create the TRX ID.

According to various embodiments, at operation 1377, the payment service server 1330 may transmit the PID and the TRX ID to the first electronic device 1310.

According to various embodiments, the first electronic device 1310 may include a payment application for performing authentication of a token. For example, at operation 1378, the first electronic device 1310 may deliver the PID and the TRX ID from the integrated payment application to the payment application, and may perform a payment operation.

According to various embodiments, at operation 1379, the first electronic device 1310 may send a TRX ID and a token to the payment gateway 1340. Namely, unlike the Korean model, the US model may omit a separate FIDO authentication procedure and may use an actual token instead of the OTC.

According to various embodiments, at operation 1380, the payment gateway 1340 may transmit the token and price information to an acquirer bank 1350. Then, at operation 1381, the acquirer bank 1350 may deliver the token and the price information to a card network 1360. At operation 1382, the card network 1360 may send a PAN and the price information to an issuer bank 1370. For example, the card network 1360 may send the PAN corresponding to the received token to the issuer bank 1370.

According to various embodiments, the issuer bank 1370 may transmit an approval result to the card network 1360 at operation 1383, and the card network 1360 may deliver the approval result to the acquirer bank 1350 at operation 1384. Also, the acquirer bank 1350 may send the approval result to the payment gateway 1340 at operation 1385. Then, at operation 1386, the payment gateway 1340 may send the approval result to the first electronic device 1310. For example, the approval result may be sent to the payment application of the first electronic device 1310 and then delivered to the integrated payment application at operation 1387.

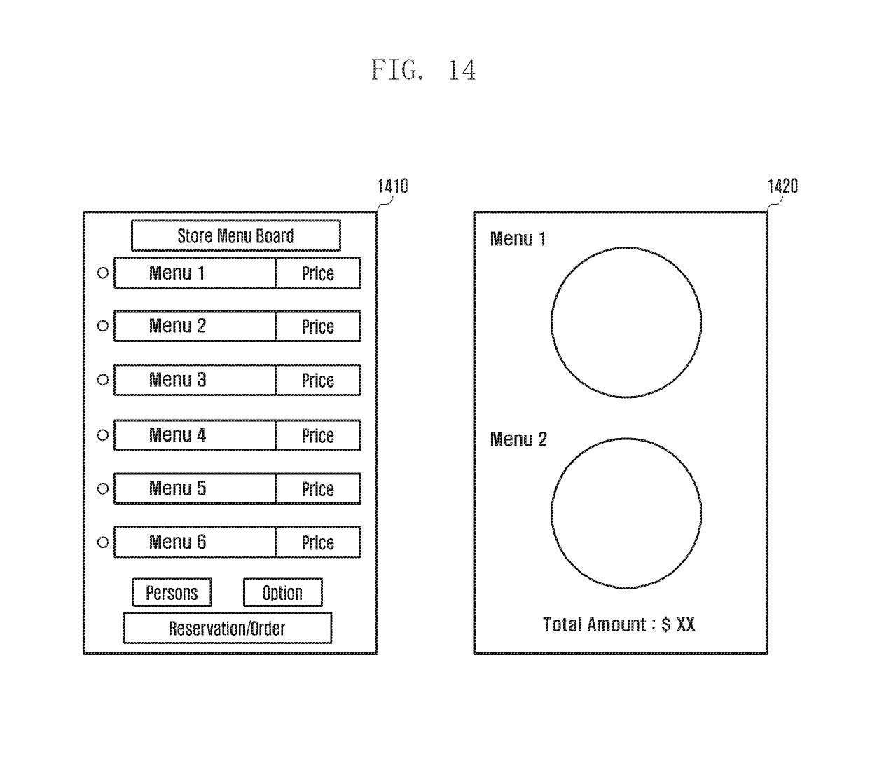

FIG. 14 is a diagram illustrating an example user interface for providing information about menu and price to users through an electronic device according to various example embodiments of the present disclosure.

According to various embodiments, when a merchant registers its account in the payment service server, the payment service server may provide at least one function. For example, the payment service server may provide a web page to the merchant, and the merchant may offer a store menu board 1410 to users (i.e., customers) through the web page. Then, through the store menu board 1410, the user may select at least one menu (e.g., menu 1˜menu 6), a price corresponding to the menu, the number of persons, and any other option.

According to various embodiments, the merchant may register information about articles and prices in its own account of the payment service server and may also receive a reservation or order from the user. For example, the users may search for and access a web site opened with the merchant's account, or directly access the web site by using a uniform resource locator (URL).

According to various embodiments, the electronic device (e.g., 101 in FIG. 1) may receive a user's input for selecting a menu 1 and a menu 2 from the menu board 1410 and thus shows the selected menus and a total amount to the user as denoted by a reference numeral 1420. User interfaces 1410 and 1420 may be provided through the above-discussed integrated payment application of the electronic device.

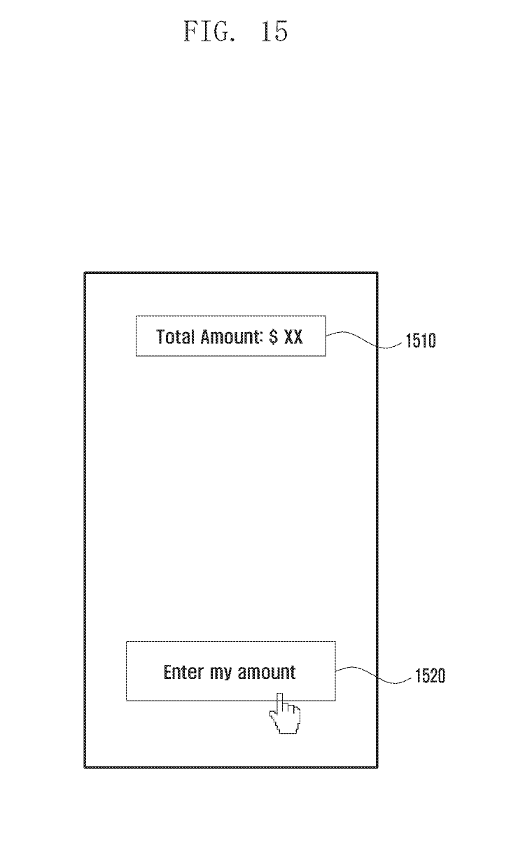

FIG. 15 is a diagram illustrating an example user interface for inputting an amount to be paid through an electronic device according to various embodiments of the present disclosure.

According to various embodiments, the electronic device (e.g., 101 in FIG. 1) may receive a total amount 1510 to be paid from a merchant (e.g., the above-discussed operations 971, 974, 984, 1071, 1171, 1271 and 1371), and may also receive an input for user's portion 1520 from the user.

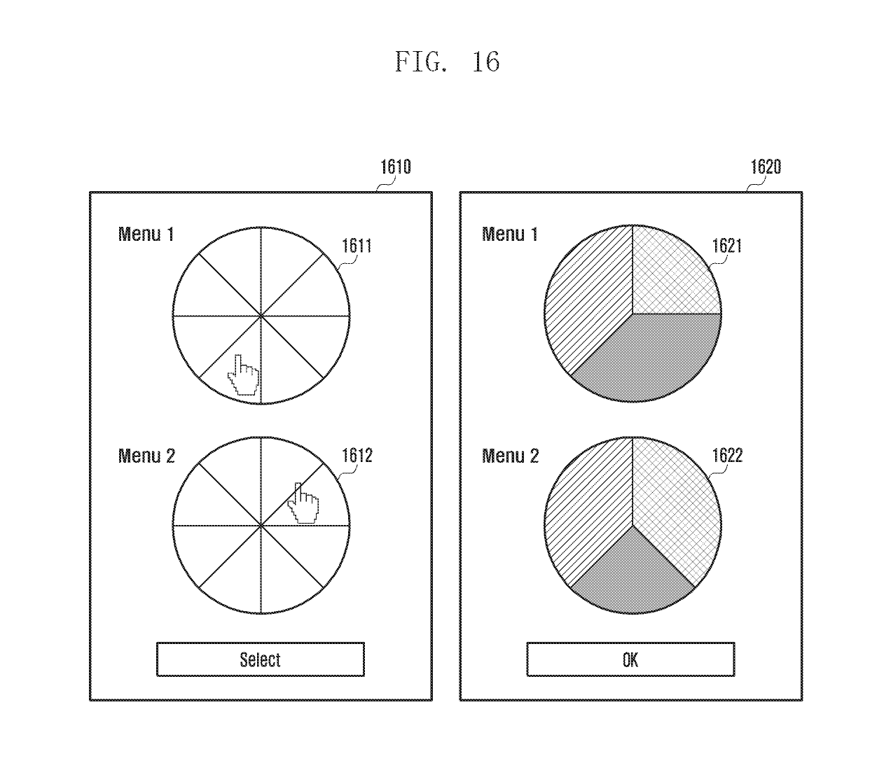

FIG. 16 is a diagram illustrating an example user interface for calculating a Dutch pay amount price according to various example embodiments of the present disclosure.

According to various embodiments, the electronic device (e.g., 101 in FIG. 1) may provide a UI 1610 that displays articles to be paid (e.g., menu 1, menu 2, etc.) and corresponding prices. For example, as denoted by reference numerals 1611 and 1612, the electronic device may divide the amount corresponding to each article (e.g., menu 1, menu 2, etc.) equally (e.g., dividing into eight) and represent them in a plurality of areas. The user of the electronic device may select an area corresponding to his or her portion. Further, although not shown in the UI 1610, the electronic device may also provide a portion amount corresponding to the divided area to the user. For example, if the price of menu 1 is 8 dollars, each divided area may be represented together with 1 dollar.

According to various embodiments, the electronic device (e.g., 101 in FIG. 1) may receive an input for each user's portion from one of users participating in Dutch pay. For example, referring to a UI 1620, if three users participate in Dutch pay, a representative of the three users may allocate a Dutch pay amount (i.e., portion) to each user. For example, the allocated amounts may be represented distinctively with at least one of size, color, and texture as denoted by reference numerals 1621 and 1622.

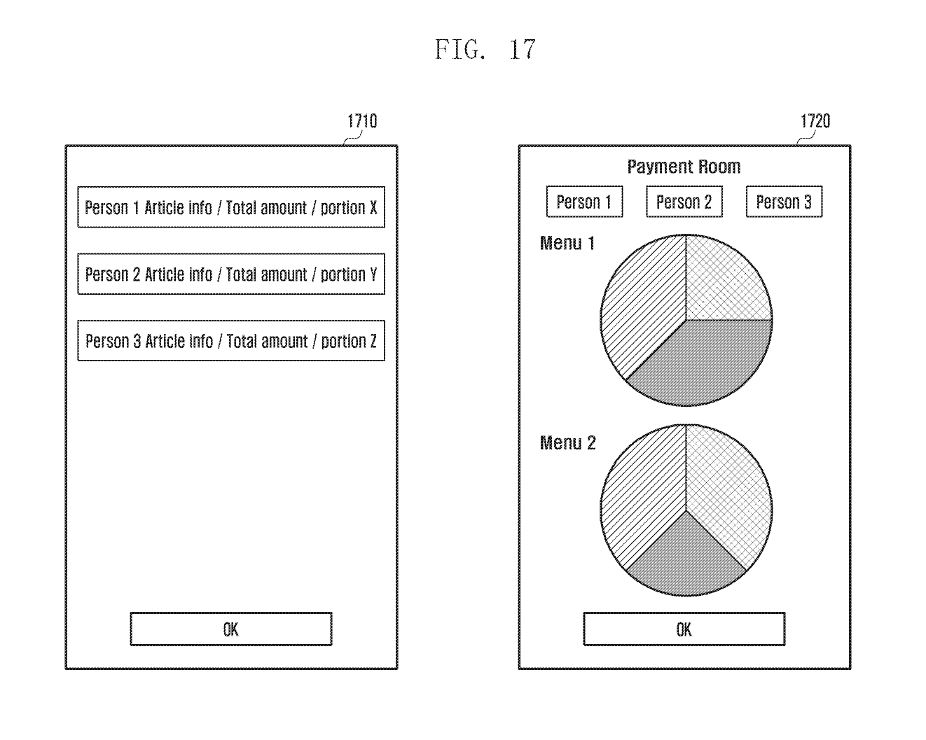

FIG. 17 is a diagram illustrating an example user interface for transferring a calculated Dutch pay amount to other electronic devices according to various example embodiments of the present disclosure.

According to various embodiments, the electronic device (e.g., 101 in FIG. 1) may deliver the allocated amounts for Dutch pay to other electronic devices of other users participating in Dutch pay. For example, instead of entering each portion by each user, the representative of users may allocate respective portions for the other users as shown in FIG. 16 and then notify them to the other users. Referring to UIs 1710 and 1720, the representative's electronic device may receive an input for information (e.g., article information, total amount, payment portion, etc.) corresponding to users (e.g., person 1, person 2, person 3) who will participate in Dutch pay, and then may send it to the other users' electronic devices. For example, the representative's electronic device may forward the information to the other users via SMS, MIMS, messenger or SNS service. Referring to the UI 1720, the electronic device may create a separate payment room for Dutch pay, invite users (e.g., persons 1-3) participating in Dutch Pay, and modify information (e.g., each user's payment portion) about Dutch pay.

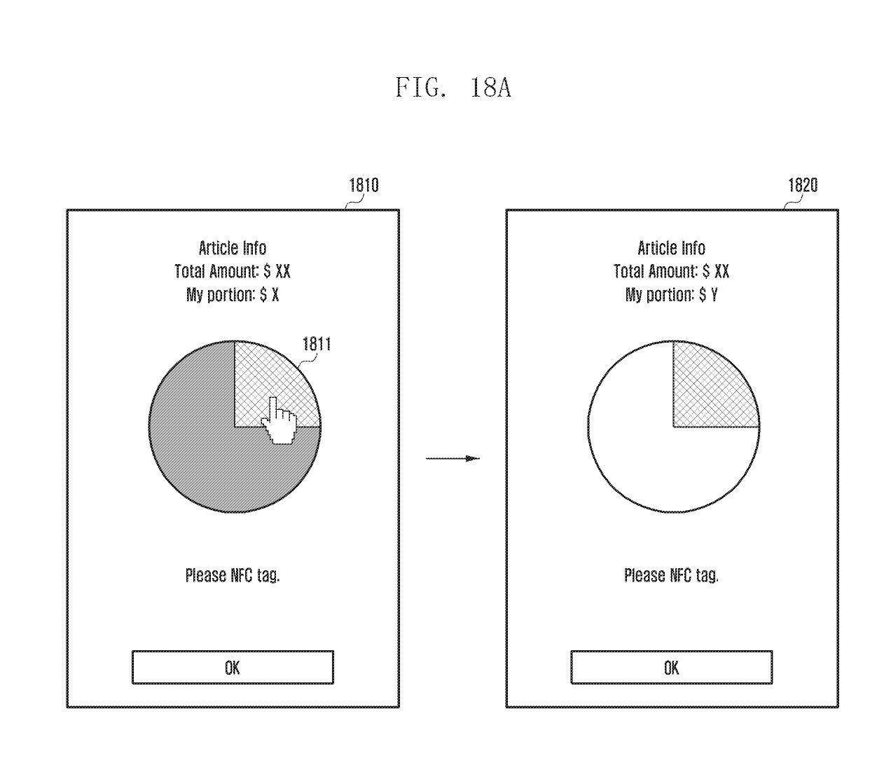

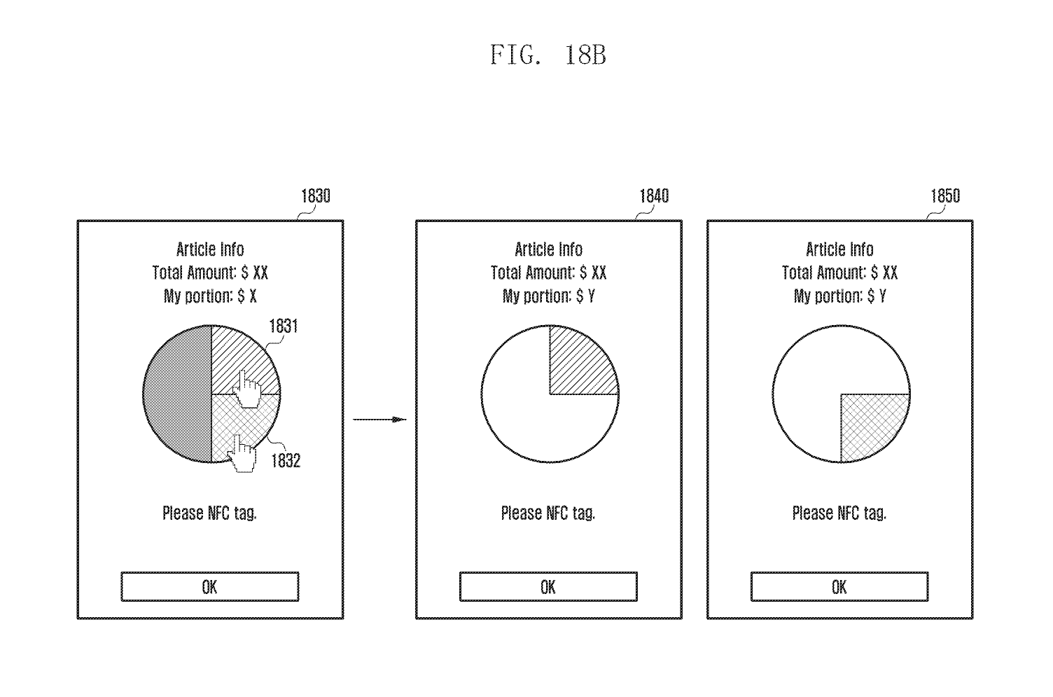

FIGS. 18A and 18B are diagrams illustrating another example user interface for transferring a calculated Dutch pay amount to other electronic devices according to various example embodiments of the present disclosure.

According to various embodiments, the electronic device (e.g., 101 in FIG. 1) may deliver, using P2P communication, information about a payment amount to each user participating in Dutch pay.

According to various embodiments, referring to UIs 1810 and 1820, if there are two users participating in Dutch pay, the representative may select a portion 1811 of the other user (e.g., friend 1). This selection may be performed, for example, by tapping or dragging a divided area in the total amount. Then the electronic device (e.g., 101 in FIG. 1) may send information about Dutch pay to other electronic device (e.g., 102 in FIG. 1) through P2P communication (e.g., NFC tag).

According to various embodiments, referring to UIs 1830, 1840 and 1850, if there are three users participating in Dutch pay, the representative may select two portions 1831 and 1832 of the other users (e.g., friend 1, friend 2). This selection may be performed, for example, by tapping or dragging divided areas in the total amount. Then the electronic device (e.g., 101 in FIG. 1) may send information about Dutch pay to other electronic devices (e.g., 102 in FIG. 1) through P2P communication (e.g., NFC tag).

According to various embodiments, the electronic device (e.g., 101 in FIG. 1) may receive other user's input for his or her portion through P2P communication. Namely, instead of allocating each user's portion by one representative, each user may enter his or her own portion.

According to various embodiments, instead of P2P communication (e.g., NFC tag) as used in FIGS. 18A and 18B, any other local network connection such as Wi-Fi may be used for transmission and reception of information about Dutch pay. Here, a process of searching for services of other electronic devices and transmitting or receiving data may follow a general local network service search method. For example, if the service daemon of the device that receives information waits at a specific port and if the transmitting device broadcasts a packet through the specific port, the receiving device may read the packet.

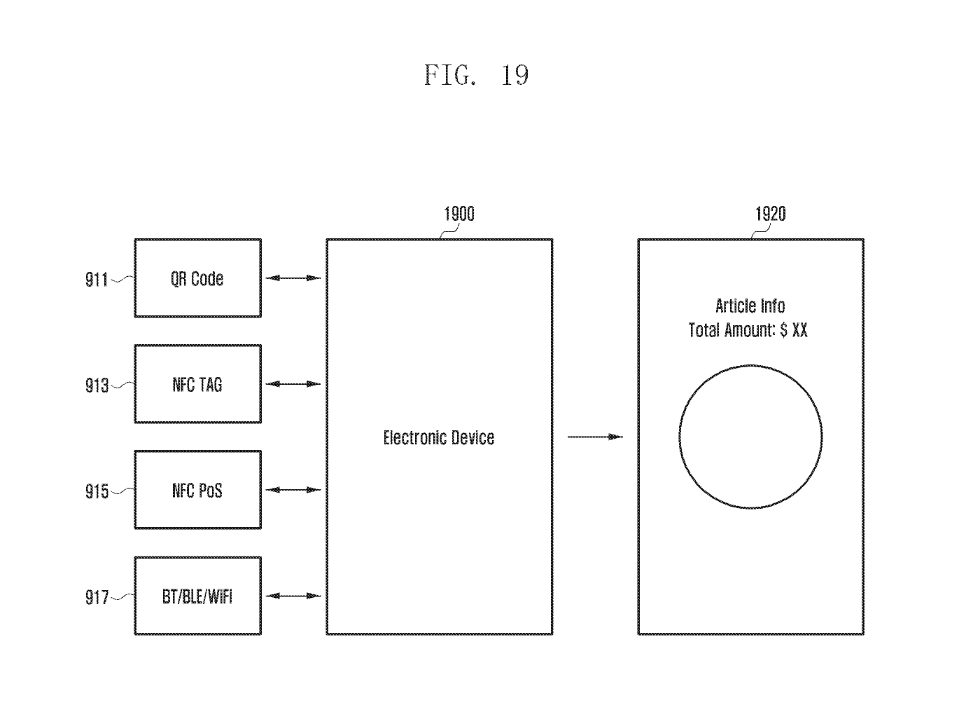

FIG. 19 is a diagram illustrating example schemes of receiving payment information for Dutch pay from a store according to various example embodiments of the present disclosure.

According to various embodiments, the electronic device 1900 (e.g., 101 in FIG. 1) may receive order information from a merchant by using at least one of a QR code 911, an NFC tag 913, a PoS 915, and BT/BLE/WiFi 917. Then the electronic device 1900 may display the received order information (e.g., article information, a total amount, etc.) to the user as denoted by a reference numeral 1920.

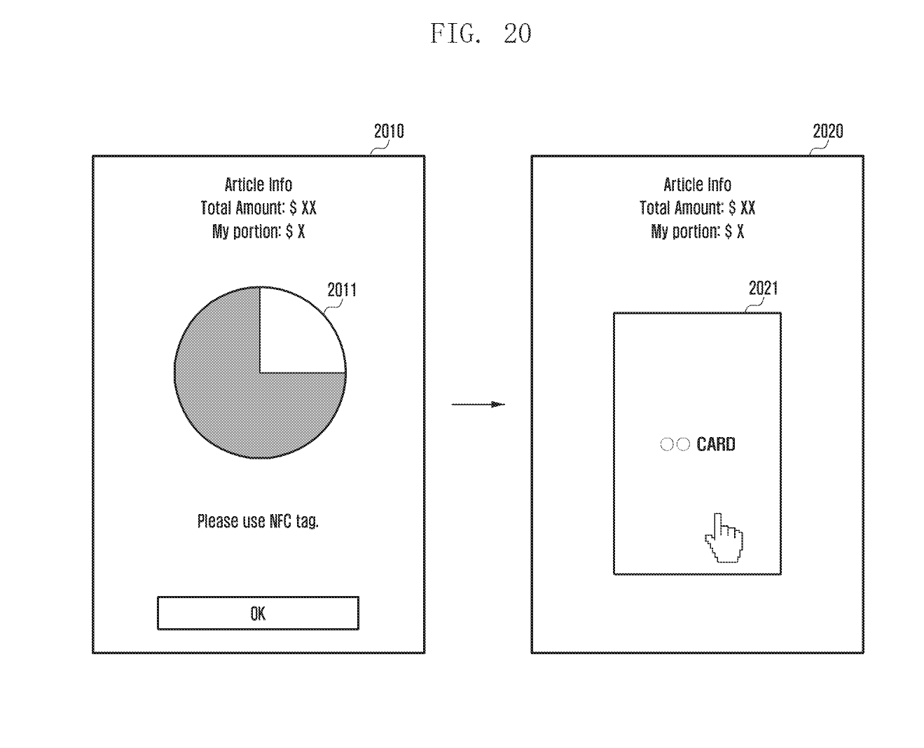

FIG. 20 is a diagram illustrating an example user interface for performing payment with created payment information for Dutch pay according to various example embodiments of the present disclosure.

According to various embodiments, when an input for a user's Dutch pay portion 2011 is received as shown in the UI 2010, the electronic device (e.g., 101 in FIG. 1) may perform a payment through a payment means 2021 (e.g., Samsung Card) as shown in the UI 2020.

As fully discussed hereinbefore, a store can provide a Dutch pay service through the payment service server without constructing its own server, and also can issue only one receipt, rather than a plurality of receipts, to users. In addition, users can easily use the Dutch pay service by using their own payment means (e.g., a cash card, a credit card, a gift coupon, etc.).

An electronic device according to various embodiments may include a communication module comprising communication circuitry; a memory configured to store information about at least one payment means; and a processor. The processor may be configured to receive, using the communication module, identification information about a first external electronic device and order information in connection with a payment from the first external electronic device, to transmit, using the communication module, information about a portion of an amount corresponding to the payment, the identification information, and the order information to a second external electronic device for paying the portion such that the second external electronic device transmits first authentication information for the portion to a third external electronic device capable of performing authentication for the payment, and to transmit, using the communication module, the identification information, the order information, and second authentication information of the electronic device for paying another portion of the amount to the third external electronic device such that the third external electronic device performs authentication for the payment by using the identification information, the order information, the first authentication information, and the second authentication information.

The processor may be further configured to transmit the information about the portion, the identification information, and the order information to the second external electronic device using a short range communication module including short-range communication circuitry contained in the communication module.

The processor may be further configured to receive an input for sharing the amount corresponding to the payment with the second external electronic device, and to receive an input for selecting the portion and the another portion of the amount corresponding to the payment.

The processor may be further configured to receive a request for modification of the portion from the second external electronic device, and to receive an input for reselecting the portion and the another portion in response to the modification request.

The processor may be further configured to transmit information containing a uniform resource locator (URL) of the first external electronic device to the second external electronic device such that the second external electronic device accesses the URL of the first external electronic device, and the URL may include information about the portion, the identification information, and the order information.

The processor may be further configured to receive an input for selecting a specific one of the at least one payment means by using a display or an audio module.

The authentication information may include a token or signature information corresponding to the specific payment means.

The processor may be further configured to use a permanently issued token or a one-time issued token for the payment.

The processor may be further configured to receive a transaction ID (TRX ID) and a payment ID (PID) for approval of the payment from the third external electronic device if the third external electronic device determines that a sum of the portion and the another portion is equal to the amount corresponding to the payment.

The processor may be further configured to transmit a transaction ID (TRX ID) and a token stored in the memory to the third external electronic device if the TRX ID and a payment ID (PID) for approval of the payment is received from the third external electronic device.

The processor may be further configured to send a request for a fast identity online (FIDO) to the third external electronic device if a transaction ID (TRX ID) and a payment ID (PID) for approval of the payment is received from the third external electronic device.

The processor may be further configured to send a request for issuance of a token to the third external electronic device after the FIDO is completed.

The processor may be further configured to determine, based on contextual information, the second external electronic device to share the amount corresponding to the payment.

The contextual information may be determined based on at least one of a motion, a time, a place, and a part of the place.

The processor may be further configured to include information about at least one of a contact, a messenger, and a social network service (SNS), and to transmit the information about the portion, the identification information, and the order information to the second external electronic device by using the information about the at least one of the contact, the messenger, and the SNS.

A system according to various embodiments may include a first external electronic device configured to transmit identification information about the first external electronic device and order information in connection with a payment to an electronic device; the electronic device configured to receive an amount corresponding to the payment, the identification information, and the order information from the first external electronic device, to divide the amount corresponding to the payment into a first portion and a second portion, to transmit information about the first portion, the identification information, and the order information to a second external electronic device for paying the first portion, and to transmit first authentication information for the second portion to a third external electronic device capable of performing authentication for the payment; the second external electronic device configured to receive the information about the first portion, the identification information, and the order information from the electronic device, and to transmit second authentication information for the first portion to the third external electronic device; and the third external electronic device configured to perform authentication for the payment by using the first authentication information received from the electronic device and the second authentication information received from the second external electronic device.

An electronic device according to various embodiments may include a communication module comprising communication circuitry; a memory; and a processor configured to receive, using the communication module, identification information about a third electronic device, order information, and information about a payment means from a first electronic device and a second electronic device in connection with a payment, to request the third electronic device to confirm the order information, and to transmit a transaction ID (TRX ID) and a payment ID (PID) to the first and second electronic devices when the order information is confirmed.

The processor may be further configured to transmit the TRX ID and the PID to the first and second electronic devices if an amount corresponding to the payment is equal to a sum of a first portion received from the first electronic device and a second portion received from the second electronic device.

The processor may be further configured to perform approval of the payment if the TRX ID and a token are received from the first and second electronic devices.

The processor may be further configured to perform a fast identity online (FIDO) in response to a request of the first and second electronic devices, and to transmit a token to the first and second electronic devices if the FIDO is completed.

The term “module” used in the present disclosure may refer, for example, to a unit including one or more combinations of hardware, software, and firmware. The “module” may be interchangeable with a term, such as “unit,” “logic,” “logical block,” “component,” or “circuit”. The “module” may be a minimum unit of a component formed as one body or a part thereof, may be a minimum unit for performing one or more functions or a part thereof, and may be implemented mechanically or electronically. For example, the “module” according to an example embodiment of the present disclosure may include, for example, and without limitation, at least one of a dedicated processor, a CPU, an application-specific integrated circuit (ASIC) chip, a field-programmable gate array (FPGA), and a programmable-logic device for performing certain operations which have been known or are to be developed in the future.

Examples of computer-readable media include: magnetic media, such as hard disks, floppy disks, and magnetic tape; optical media such as compact disc read only memory (CD-ROM) disks and digital versatile disc (DVD), magneto-optical media, such as floptical disks, and hardware devices that are specially configured to store and perform program instructions, such as ROM, RAM, and flash memory. Examples of program instructions include machine code instructions created by assembly languages, such as a compiler, and code instructions created by a high-level programming language executable in computers using an interpreter. The described hardware devices may be configured to act as one or more software modules in order to perform the operations and methods described above, or vice versa.

Modules or programming modules according to the embodiments of the present disclosure may include one or more components, remove part of the components described above, or include new components. The operations performed by modules, programming modules, or the other components, according to the present disclosure, may be executed in serial, parallel, repetitive or heuristic fashion. Part of the operations can be executed in any other order, omitted, or executed with additional operations.

Although various example embodiments of the disclosure have been described in detail above, it should be understood that many variations and modifications of the basic technical concept herein described, which may be apparent to those skilled in the art, will fall within the spirit and scope of the embodiments of the disclosure as defined in the appended claims.

What is claimed is:

1. An electronic device comprising:
a communication module comprising communication circuitry;
a memory configured to store information about at least one payment means; and
a processor configured to:
receive, using the communication module, identification information about a first external electronic device and order information in connection with a payment from the first external electronic device,
transmit, using the communication module, information about a portion of an amount corresponding to the payment, the identification information, and the order information to a second external electronic device for paying the portion such that the second external electronic device transmits first authentication information for the portion to a third external electronic device capable of performing authentication for the payment, and
transmit, using the communication module, the identification information, the order information, and second authentication information of the electronic device for paying another portion of the amount to the third external electronic device such that the third external electronic device performs authentication for the payment using the identification information, the order information, the first authentication information, and the second authentication information.

2. The electronic device of claim 1, wherein the processor is further configured to transmit the information about the portion, the identification information, and the order information to the second external electronic device using a short-range communication module comprising short-range communication circuitry contained in the communication module.

3. The electronic device of claim 1, wherein the processor is further configured to receive an input for sharing the amount corresponding to the payment with the second external electronic device, and to receive an input for selecting the portion and the another portion of the amount corresponding to the payment.

4. The electronic device of claim 3, wherein the processor is further configured to receive a request for modification of the portion from the second external electronic device, and to receive an input for reselecting the portion and the another portion in response to the modification request.

5. The electronic device of claim 1, wherein the processor is further configured to transmit information including a uniform resource locator (URL) of the first external electronic device to the second external electronic device wherein the second external electronic device is configured to access the URL of the first external electronic device, and
wherein the URL includes information about the portion, the identification information, and the order information.

6. The electronic device of claim 1, wherein the processor is further configured to receive an input for selecting a specific one of the at least one payment means using a display or an audio module.

7. The electronic device of claim 7, wherein the authentication information includes a token or signature information corresponding to the specific payment means.

8. The electronic device of claim 7, wherein the processor is further configured to use a permanently issued token or a one-time issued token for the payment.

9. The electronic device of claim 1, wherein the processor is further configured to receive a transaction ID (TRX ID) and a payment ID (PID) for approval of the payment from the third external electronic device if the third external electronic device determines that a sum of the portion and the another portion is equal to the amount corresponding to the payment.

10. The electronic device of claim 1, wherein the processor is further configured to transmit a transaction ID (TRX ID) and a token stored in the memory to the third external electronic device if the TRX ID and a payment ID (PID) for approval of the payment is received from the third external electronic device.

11. The electronic device of claim 1, wherein the processor is further configured to send a request for a fast identity online (FIDO) to the third external electronic device if a transaction ID (TRX ID) and a payment ID (PID) for approval of the payment is received from the third external electronic device.

12. The electronic device of claim 11, wherein the processor is further configured to send a request for issuance of a token to the third external electronic device after the FIDO is completed.

13. The electronic device of claim 1, wherein the processor is further configured to determine, based on contextual information, the second external electronic device to share the amount corresponding to the payment.

14. The electronic device of claim 13, wherein the contextual information is determined based on at least one of: a motion, a time, a place, and a part of the place.

15. The electronic device of claim 1, wherein the processor is further configured to include information about at least one of a contact, a messenger, and a social network service (SNS), and to transmit the information about the portion, the identification information, and the order information to the second external electronic device using the information about the at least one of the contact, the messenger, and the SNS.

16. A system comprising:
a first external electronic device configured to transmit identification information about the first external electronic device and order information corresponding to a payment to an electronic device;
the first external electronic device configured to receive an amount corresponding to the payment, the identification information, and the order information from the first external electronic device, to divide the amount corresponding to the payment into a first portion and a second portion, to transmit information about the first portion, the identification information, and the order information to a second external electronic device for paying the first portion, and to transmit first authentication information for the second portion to a third external electronic device capable of performing authentication for the payment;
the second external electronic device configured to receive the information about the first portion, the identification information, and the order information from the first external electronic device, and to transmit second authentication information for the first portion to the third external electronic device; and
the third external electronic device configured to perform authentication for the payment using the first authentication information received from the first external electronic device and the second authentication information received from the second external electronic device.

17. An electronic device comprising:
a communication module comprising communication circuitry;
a memory; and
a processor configured to:
receive, using the communication module, identification information about a third electronic device, order information, and information about a payment means from a first electronic device and a second electronic device corresponding to a payment,
request the third electronic device to confirm the order information, and
transmit a transaction ID (TRX ID) and a payment ID (PID) to the first and second electronic devices when the order information is confirmed.

18. The electronic device of claim 17, wherein the processor is further configured to transmit the TRX ID and the PID to the first and second electronic devices if an amount corresponding to the payment is equal to a sum of a first portion received from the first electronic device and a second portion received from the second electronic device.

19. The electronic device of claim 17, wherein the processor is further configured to perform approval of the payment if the TRX ID and a token are received from the first and second electronic devices.

20. The electronic device of claim 17, wherein the processor is further configured to perform a fast identity online (FIDO) in response to a request of the first and second electronic devices, and to transmit a token to the first and second electronic devices if the FIDO is completed.
